(19) United States
(12) Patent Application Publication
(10) Pub. No.: US 2024/0416329 A1
(43) Pub. Date: Dec. 19, 2024

(54) METHODS OF FORMING ZEOLITE COMPOSITIONS AND CATALYST COMPOSITIONS

(71) Applicants: Saudi Arabian Oil Company, Dhahran (SA); King Fahd University of Petroleum and Minerals, Dhahran (SA)

(72) Inventors: Aaron Chi Akah, Dhahran (SA); Rabindran Jermy, Dammam (SA); Ziyauddin S. Qureshi, Dhahran (SA); Abdullah M. Aitani, Khobar (SA); M. Abdulbari Siddiqui, Dhahran (SA)

(73) Assignees: Saudi Arabian Oil Company, Dhahran (SA); King Fahd University of Petroleum and Minerals, Dhahran (SA)

(21) Appl. No.: 18/739,902

(22) Filed: Jun. 11, 2024

Related U.S. Application Data
(60) Provisional application No. 63/508,076, filed on Jun. 14, 2023.

(51) Int. Cl. B01J 29/48; B01J 37/02; B01J 37/10; B01J 37/30

(52) U.S. Cl. CPC B01J 29/48; B01J 37/0201; B01J 37/10; B01J 37/30

(57) ABSTRACT

This disclosure relates to methods of forming a zeolite composition, the method comprising calcining one or more clay mineral compositions to form metakaolin, wherein the one or more clay mineral compositions may comprise greater than or equal to 10 wt. % halloysite, forming a slurry by combining at least the metakaolin, a shape selective zeolite, a basic compound, silica particles, and a templating agent, hydrothermally treating the slurry to form a hydrothermal product, calcining the hydrothermal product to form a zeolite product, combining the zeolite product and at least one metal precursor, wherein the at least one metal precursor may comprise a manganese precursor, a phosphorous precursor, or both a manganese precursor and a phosphorous precursor to form a zeolite composition comprising manganese, phosphorus, or both manganese and phosphorous.

### CROSS-REFERENCE TO RELATED APPLICATIONS

This application claims the benefit of U.S. Provisional Application Ser. No. 63/508,076 filed Jun. 14, 2023, the contents of which are incorporated in their entirety herein.

### FIELD

Embodiments disclosed herein generally relate to chemical processing and, more specifically, to zeolites and catalyst compositions that include zeolites.

### TECHNICAL BACKGROUND

The worldwide increasing demand for olefins remains a major challenge for many integrated refineries. In particular, the production of some valuable olefins, such as ethylene and propylene, has attracted increased attention as pure olefin streams are considered the building blocks for polymer synthesis. The production of olefins depends on several process variables, such as the feed type, operating conditions, and the type of catalyst used. Many cracking catalysts utilize a zeolite as support material. However, there are limitations in heavy oil conversion and stability of these catalysts. For example, conventional catalysts may have poor polyaromatic cracking conversion. Accordingly, new zeolites and zeolite-based catalysts with various improved attributes are needed.

### BRIEF SUMMARY

There is a need for methods of making zeolite compositions and catalyst compositions including such zeolite compositions. Conventional zeolite compositions may be formed by processes that utilized calcining kaolinite to form metakaolin, prior to making the zeolite composition. Presently discovered, and included in the embodiments described herein, are methods in which zeolite compositions and catalyst compositions are produced by calcining a clay mineral composition having greater than or equal to 10 weight percent halloysite to form metakaolin prior to making the zeolite composition. Such embodiments may yield zeolite compositions and catalyst compositions that include the zeolite compositions that demonstrate improved efficiency in hydrocarbon cracking.

According to one or more embodiments, a method of forming a zeolite composition, the method may comprise calcining one or more clay mineral compositions to form metakaolin, wherein the one or more clay mineral compositions may comprise greater than or equal to 10 wt. % halloysite, forming a slurry by combining at least the metakaolin, a shape selective zeolite, a basic compound, silica particles, and a templating agent, hydrothermally treating the slurry to form a hydrothermal product, calcining the hydrothermal product to form a zeolite product, combining the zeolite product and at least one metal precursor, wherein the at least one metal precursor may comprise a manganese precursor, a phosphorous precursor, or both a manganese precursor and a phosphorous precursor to form a zeolite composition comprising manganese, phosphorus, or both manganese and phosphorous.

According to one or more additional embodiments, a method of forming a catalyst composition, the method may comprise calcining one or more clay mineral compositions to form metakaolin, wherein the one or more clay mineral compositions may comprise greater than or equal to 10 wt. % halloysite, forming a slurry by combining at least the metakaolin, a shape selective zeolite, a basic compound, silica particles, and a templating agent, hydrothermally treating the slurry to form a hydrothermal product, calcining the hydrothermal product to form a zeolite product, combining the zeolite product and at least one metal precursor, wherein the at least one metal precursor may comprise a manganese precursor, a phosphorous precursor, or both a manganese precursor and a phosphorous precursor to form a zeolite composition comprising manganese, phosphorus, or both manganese and phosphorous, forming a catalyst precursor comprising the zeolite composition, kaolin clay, and alumina, and drying and calcining the catalyst precursor to form the catalyst composition.

This summary is provided to introduce a selection of concepts that are further described in the detailed description. This summary is not intended to identify key or essential features of the claimed subject matter, nor is it intended to be used as an aid in limiting the scope of the claimed subject matter.

Additional features and advantages of the described embodiments will be set forth in the detailed description that follows. The additional features and advantages of the described embodiments will be, in part, readily apparent to those skilled in the art from that description or recognized by practicing the described embodiments, including the detailed description that follows as well as the drawings and the claims.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a method flow diagram, according to one or more embodiments shown and described herein;

FIG. 2 is a method flow diagram, according to one or more embodiments shown and described herein;

FIG. 3 graphically depicts X-ray diffraction spectra, according to one or more embodiments shown and described herein;

FIG. 4 graphically depicts X-ray diffraction spectra, according to one or more embodiments shown and described herein;

FIG. 5 graphically depicts X-ray diffraction spectra, according to one or more embodiments shown and described herein;

FIG. 6 graphically depicts pore volume (y-axis) as a function of pore width (x-axis), according to one or more embodiments shown and described herein;

FIG. 7 graphically depicts nitrogen adsorption-desorption isotherms, according to one or more embodiments shown and described herein;

FIG. 8 graphically depicts weight loss (y-axis) as a function of temperature (° C.) (x-axis) resulting from thermogravimetric analysis, according to one or more embodiments shown and described herein;

FIG. 9 graphically depicts X-ray diffraction spectra, according to one or more embodiments shown and described herein;

FIG. 10 graphically depicts thermal conductivity detector intensity (y-axis) as a function of temperature (° C.) (x-axis) resulting from ammonia desorption analysis, according to one or more embodiments shown and described herein;

FIG. 11 graphically depicts thermal conductivity detector intensity (y-axis) as a function of temperature (° C.) (x-axis) resulting from ammonia desorption analysis, according to one or more embodiments shown and described herein;

FIG. 12 graphically depicts diffuse reflectance spectra comprising absorbance (y-axis) as a function of wavelength (x-axis), according to one or more embodiments shown and described herein;

FIG. 13 graphically depicts diffuse reflectance spectra comprising absorbance (y-axis) as a function of wavelength (x-axis), according to one or more embodiments shown and described herein;

FIG. 14 is a generalized schematic diagram of a fixed-bed reaction system, according to one or more embodiments shown and described herein;

Reference will now be made in greater detail to various embodiments, some embodiments of which are illustrated in the accompanying drawings.

### DETAILED DESCRIPTION

Presently described, according to one or more embodiments, are methods of forming zeolite compositions. As used in this disclosure, a “zeolite composition” may refer to any substance that includes a zeolitic material. Zeolite compositions described in this disclosure may be utilized to promote various reactions, such as, but not limited to, cracking of a hydrocarbon feed stream.

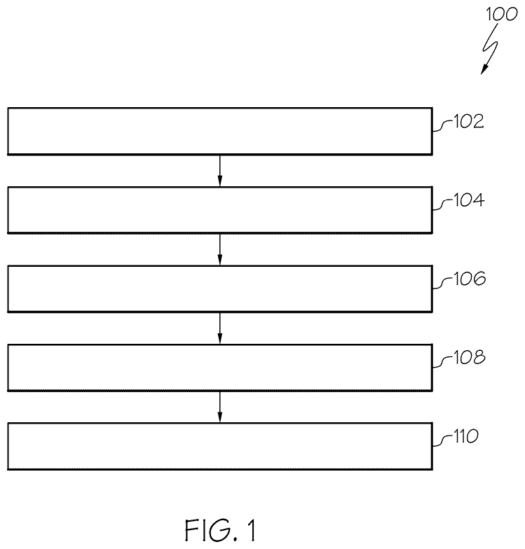

Turning now to FIG. 1, a method 100 of forming a zeolite composition is depicted. As depicted, FIG. 1 includes a series of “blocks” which are each representative of one or more steps in the processes presently described. Generally, the process steps, indicated and sometimes referred to as blocks herein, are ordered as depicted in FIG. 1. The process of FIG. 1 generally includes calcining one or more clay mineral compositions to form metakaolin (at block 102), forming a slurry by combining at least the metakaolin, a shape selective zeolite, a basic compound, silica particles, and a templating agent (at block 104), hydrothermally treating the slurry to form a hydrothermal product (at block 106), calcining the hydrothermal product to form a zeolite product (at block 108), and combining the zeolite product and at least one metal precursor to form a zeolite composition (at block 110).

As described herein, at block 102, the method may include calcining one or more clay mineral compositions to form metakaolin. As used herein, “calcining” may refer to heating a material to an elevated temperature, and holding the temperature of the material at an elevated temperature for a duration of time in an environment comprising oxygen. As used herein, “clay mineral composition” may refer to a composition of one or more clay minerals. A clay mineral composition may comprise one or more clay minerals, such as kaolinite and halloysite. In embodiments, two or more clay mineral compositions may be used. That is, in embodiments, at least two separate clay mineral compositions comprising a different weight percentage of clay minerals may be used as described herein. When a weight percentage of a specific clay mineral, such as halloysite, is provided for the “one or more clay mineral compositions”, the weight percentage may refer to the weight of the specific clay mineral in relation to the summation of the one or more clay mineral compositions, unless specified otherwise.

In embodiments, the one or more clay mineral compositions may comprise kaolin. As used herein, “kaolin” or “kaolin clay” refers to a class of clay minerals comprising the chemical formula Al₂Si₂O₅(OH)₄, which may include the clay minerals kaolinite, halloysite, dickite, and nacrite. In embodiments, the one or more clay mineral compositions may comprise halloysite, kaolinite, dickite, nacrite or combinations thereof. Kaolinite has the chemical formula Al₂Si₂O₅(OH)₄, and may occur in platy forms. Halloysite has a similar composition to kaolinite except that halloysite may naturally occur as small cylinders and may have additional water molecules. In its fully hydrated form, halloysite has additional water molecules between layers of the crystal structure with a chemical formula of Al₂Si₂O₅(OH)₄·2H₂O. Halloysite may also be partially dehydrated. As used herein, “halloysite” may refer to both the fully hydrated and partially hydrated form of halloysite, unless specified otherwise.

In embodiments, the one or more clay mineral compositions may comprise greater than or equal to 10 weight percent (wt. %) halloysite, such as greater than or equal to 15 wt. %, greater than or equal to 20 wt. %, greater than or equal to 25 wt. %, greater than or equal to 30 wt. %, greater than or equal to 35 wt. %, greater than or equal to 40 wt. %, greater than or equal to 45 wt. %, greater than or equal to 50 wt. %, greater than or equal to 55 wt. %, greater than or equal to 60 wt. %, greater than or equal to 65 wt. %, greater than or equal to 70 wt. %, greater than or equal to 75 wt. %, greater than or equal to 80 wt. %, greater than or equal to 85 wt. %, greater than or equal to 90 wt. %, greater than or equal to 95 wt. %, greater than or equal to 99 wt. %, or even greater than or equal to 99.99 wt. % halloysite, based on the total weight of the one or more clay mineral compositions. In embodiments, the one or more clay mineral compositions may comprise of from 10 wt. % to 100 wt. % halloysite, such as from 20 wt. % to 100 wt. %, from 30 wt. % to 100 wt. %, from 40 wt. % to 100 wt. %, from 50 wt. % to 100 wt. %, from 60 wt. % to 100 wt. %, from 70 wt. % to 100 wt. %, from 80 wt. % to 100 wt. %, from 90 in wt. % to 100 wt. %, from 10 wt. % to 90 wt. %, from 20 wt. % to 90 wt. %, from 30 wt. % to 90 wt. %, from 40 wt. % to 90 wt. %, from 50 wt. % to 90 wt. %, from 60 wt. % to 90 wt. %, from 70 wt. % to 90 wt. %, from 80 wt. % to 90 wt. %, from 10 wt. % to 80 wt. %, from 20 wt. % to 80 wt. %, from 30 wt. % to 80 wt. %, from 40 wt. % to 80 wt. %, from 50 wt. % to 80 wt. %, from 60 wt. % to 80 wt. %, from 70 wt. % to 80 wt. %, from 10 wt. % to 70 wt. %, from 20 wt. % to 70 wt. %, from 30 wt. % to 70 wt. %, from 40 wt. % to 70 wt. %, from 50 wt. % to 70 wt. %, from 60 wt. % to 70 wt. %, from 10 wt. % to 60 wt. %, from 20 wt. % to 60 wt. %, from 30 wt. % to 60 wt. %, from 40 wt. % to 60 wt. %, from 50 wt. % to 60 wt. %, from 10 wt. % to 50 wt. %, from 20 wt. % to 50 wt. %, from 30 wt. % to 50 wt. %, from 40 wt. % to 50 wt. %, from 10 wt. % to 40 wt. %, from 20 wt. % to 40 wt. %, from 30 wt. % to 40 wt. %, from 10 wt. % to 30 wt. %, from 20 wt. % to 30 wt. %, or from 10 wt. % to 20 wt. % halloysite, based on the total weight of the one or more clay mineral compositions.

In embodiments, the one or more clay mineral compositions may comprise less than or equal to 90 weight percent (wt. %) kaolinite, such as less than or equal 50 wt. %, less than or equal to 20 wt. %, less than or equal to 10 wt. %, less than or equal to 5 wt. %, less than or equal to 2 wt. %, less than or equal to 1 wt. %, less than or equal to 0.5 wt. %, or even less than or equal to 0.1 wt. % kaolinite based on the total weight of the one or more clay mineral compositions. In embodiments, the one or more clay mineral compositions may comprise of from 0 wt. % to 90 wt. % kaolinite, such as from 0 wt. % to 80 wt. %, from 0 wt. % to 70 wt. %, from 0 wt. % to 60 wt. %, from 0 wt. % to 50 wt. %, from 0 wt. % to 40 wt. %, from 0 wt. % to 30 wt. %, from 0 wt. % to 20 wt. %, from 0 wt. % to 10 wt. %, from 0 wt. % to 5 wt. %, from 0 wt. % to 2 wt. %, from 0 wt. % to 1 wt. %, from 0 wt. % to 0.5 wt. %, based on the total weight of the one or more clay mineral compositions.

Without intending to be bound by any particular theory, it is believed that using one or more clay mineral compositions having a greater amount of halloysite, such as at least 10 wt. % halloysite, in the methods described herein may provide a zeolite composition having improved properties, such as but not limited to increased surface area in comparison to methods using one or more clay minerals having less halloysite.

In embodiments, the one or more clay minerals may be naturally occurring. As used herein, “naturally occurring” may refer to clay minerals that are not synthesized. In embodiments, the naturally occurring clay minerals may be processed. For instance, the clay minerals may be processed to remove impurities. Without intending to be bound by any particular theory, it is believed that the use of clay minerals that are naturally occurring may reduce the environmental impact of methods described herein, compared to using clay minerals that are synthesized.

In embodiments, calcining the clay minerals may comprise heating the one or more clay minerals to a temperature of greater than or equal to 550° C., such as greater than or equal to 600° C., or greater than or equal to 650° C. In embodiments, calcining the one or more clay minerals may comprise heating the one or more clay minerals to a temperature of from 550° C. to 900° C., such as from 550° C. to 800° C., from 550° C. to 750° C., from 600° C. to 900° C., from 600° C. to 800° C., from 600° C. to 750° C., from 650° C. to 900° C., from 650° C. to 800° C., or from 650° C. to 750° C. In embodiments, calcining the one or more clay minerals may comprise heating the one or more clay minerals for a duration of greater than or equal to 10 minutes (min), such as greater than or equal to 30 min, greater than or equal to 60 min, or greater than or equal to 90 min. In embodiments, calcining the one or more clay minerals may comprise heating the one or more clay minerals for a duration of from 10 min to 2 days.

In embodiments, at least a portion of the one or more clay mineral compositions may be converted to metakaolin. As used herein, “metakaolin” refers to a compound comprising chemical formula Al₂Si₂O₇. Metakaolin may be formed by heating kaolin, such as one or more clay mineral compositions comprising kaolinite, halloysite, or combinations thereof to an elevated temperature for a duration of time. In embodiments, changes in properties of the one or more clay mineral compositions may result in changes in properties of the metakaolin derived therefrom. That is, the one or more clay mineral compositions comprising an increased amount of halloysite may be converted to metakaolin having at least one or more different properties, such as average surface area or average pore volume, compared to metakaolin derived from one or more clay mineral compositions having a lesser amount of halloysite.

Surface area, pore volume, average pore size, and pore size distribution may be measured by N₂ adsorption isotherms performed at 77 Kelvin (K) (such as with a Micrometrics ASAP 2020 system). As would be understood by those skilled in the art, Brunauer, Emmett, and Teller (BET) analysis methods may be utilized to calculate the surface area, and the Barrett, Joyner and Halenda (BJH) calculation may be used to determine pore volume and pore size distribution.

In embodiments, the metakaolin may have a surface area of greater than or equal to 30 m²/g, such as greater than or equal to 35 m²/g, greater than or equal to 40 m²/g, greater than or equal to 45 m²/g, greater than or equal to 50 m²/g, greater than or equal to 55 m²/g, or even greater than or equal to 60 m²/g. In embodiments, the metakaolin may have a surface area of from 10 m²/g to 100 m²/g. For instance, in embodiments, the metakaolin may have a surface area of from 20 m²/g to 100 m²/g, from 30 m²/g to 100 m²/g, from 40 m²/g to 100 m²/g, from 50 m²/g to 100 m²/g, from 60 m²/g to 100 m²/g, from 10 m²/g to 80 m²/g, from 20 m²/g to 80 m²/g, from 30 m²/g to 80 m²/g, from 40 m²/g to 80 m²/g, from 50 m²/g to 80 m²/g, or from 60 m²/g to 80 m²/g. The surface area is determined using BET analysis.

In embodiments, the metakaolin may have an average pore volume of greater than or equal to 0.15 cm³/g, such as greater than or equal to 0.20 cm³/g, greater than or equal to 0.25 cm³/g, or greater than or equal to 0.30 cm³/g. In embodiments, the metakaolin may have an average pore volume of from 0.1 cm³/g to 0.5 cm³/g. For instance, in embodiments, the metakaolin may have an average pore volume of from 0.2 cm³/g to 0.5 cm³/g, or from 0.3 cm³/g to 0.5 cm³/g. The average pore volume is determined using BJH analysis. In embodiments, the metakaolin may have an average pore diameter of from 0.5 nm to 50 nm.

As described herein, at block 104, the method may include forming a slurry comprising the metakaolin. In embodiments, forming the slurry may include combining at least the metakaolin, a shape selective zeolite, a basic compound, silica particles, and a templating agent.

Shape selective zeolites may be active to catalytically crack hydrocarbon compounds. In embodiments, the shape selective zeolite may be an MFI structured zeolite. In embodiments, the shape selective zeolite can be ZSM-5 zeolite. As used in the present disclosure, “ZSM-5” or “ZSM-5 zeolites” refers to zeolites having an MFI framework type according to the IUPAC zeolite nomenclature and consisting of silica and alumina. ZSM-5 refers to “Zeolite Socony Mobil-5” and is a pentasil family zeolite that can be represented by the chemical formula NaₙAlₙSi₉₆₋ₙO₁₉₂·16H₂O, where 0<n<27

In embodiments, the shape selective zeolite may have a silica to alumina weight ratio (SAR) of from 10 to 280, such as from 10 to 200, from 10 to 150, from 10 to 100, from 50 to 280, from 50 to 200, from 50 to 150, or from 50 to 100.

In embodiments, the shape selective zeolite may have a surface area of greater than or equal to 200 m²/g, such as greater than or equal to 250 m²/g, greater than or equal to 300 m²/g, or greater than or equal to 350 m²/g. In embodiments. The ZSM-5 zeolite seeds may have a surface area of from 200 m²/g to 500 m²/g, from 200 m²/g to 400 m²/g, from 200 m²/g to 375 m²/g, from 250 m²/g to 500 m²/g, from 250 m²/g to 400 m²/g, from 250 m²/g to 375 m²/g, from 300 m²/g to 500 m²/g, from 300 m²/g to 400 m²/g, from 300 m²/g to 375 m²/g, from 350 m²/g to 500 m²/g, from 350 m²/g to 400 m²/g, or from 350 m²/g to 375 m²/g. The surface area is determined using BET analysis.

In embodiments, the shape selective zeolite may have an average total pore volume of greater than or equal to 0.10 cm³/g, such as greater than or equal to 0.15 cm³/g, or greater than or equal to 0.20 cm³/g. In embodiments, the ZSM-5 zeolite seeds may have an average total pore volume of less than 0.35 cm³/g, less than 0.30 cm³/g, or less than 0.25 cm³/g. In embodiments, the ZSM-5 zeolite seeds may have an average total pore volume of from 0.1 cm³/g to 0.5 cm³/g. For instance, in embodiments, the ZSM-5 zeolite seeds may have an average total pore volume of from 0.1 cm³/g to 0.4 cm³/g, from 0.1 cm³/g to 0.3 cm³/g from 0.1 cm³/g to 0.25 cm³/g, from 0.15 cm³/g to 0.4 cm³/g, from 0.15 cm³/g to 0.3 cm³/g, from 0.15 cm³/g to 0.25 cm³/g, from 0.2 cm³/g to 0.4 cm³/g, from 0.2 cm³/g to 0.3 cm³/g, or from 0.2 cm³/g to 0.25 cm³/g. The average total pore volume is determined using BJH analysis.

In embodiments, the basic compound may be any basic compound. In embodiments, the basic compound may comprise sodium hydroxide. In embodiments, the basic compound may be sodium hydroxide. In embodiments, the basic compound may comprise sodium carbonate. Without intending to be bound by any particular theory, it is believed that the basic compound may facilitate dissolution of the silica particles in the slurry.

In embodiments, the templating agent may comprise an ammonium salt, such as but not limited to tetrapropylammonium bromide (TPABr) or centrimonium bromide (CTAB). In embodiments, the ammonium salt may be a bromide salt. In embodiments. The templating agent may comprise a poloxamer, such as but not limited to Pluronic® F-127 and Pluronic® P-123, commercially available from BASF Corporation. As used herein, the term “poloxamer” may refer to a triblock copolymer comprising a central hydrophobic chain of poly(propylene oxide) and two hydrophilic chains of poly(ethylene oxide). In embodiments, the templating agent may comprise an ammonium salt, a poloxamer, or combinations thereof. In embodiments, the templating agent may be selected from an ammonium salt, a poloxamer, and combinations thereof.

In embodiments, the slurry may comprise of from 0.5 wt. % to 5 wt. % of the metakaolin, based on the total weight of the slurry. For instance, the slurry may comprise of from 0.5 wt. % to 5 wt. %, from 0.5 wt. % to 4 wt. %, from 0.5 wt. % to 3 wt. %, from 0.5 wt. % to 2 wt. %, from 0.5 wt. % to 1 wt. %, from 1 wt. % to 5 wt. %, from 1 wt. % to 4 wt. %, from 1 wt. % to 3 wt. %, from 1 wt. % to 2 wt. %, from 2 wt. % to 5 wt. %, from 2 wt. % to 4 wt. %, from 2 wt. % to 3 wt. %, from 3 wt. % to 5 wt. %, from 3 wt. % to 4 wt. %, or from 4 wt. % to 5 wt. % of the metakaolin, based on the total weight of the slurry.

In embodiments, the slurry may comprise of from 0.1 wt. % to 5 wt. % of the shape selective zeolite, based on the total weight of the slurry. For instance, the slurry may comprise from 0.1 wt. % to 5 wt. %, from 0.1 wt. % to 4 wt. %, from 0.1 wt. % to 3 wt. %, from 0.1 wt. % to 2 wt. %, from 0.1 wt. % to 1 wt. %, from 0.5 wt. % to 5 wt. %, from 0.5 wt. % to 4 wt. %, from 0.5 wt. % to 3 wt. %, from 0.5 wt. % to 2 wt. %, from 0.5 wt. % to 1 wt. %, from 1 wt. % to 5 wt. %, from 1 wt. % to 4 wt. %, from 1 wt. % to 3 wt. %, from 1 wt. % to 2 wt. %, from 2 wt. % to 5 wt. %, from 2 wt. % to 4 wt. %, from 2 wt. % to 3 wt. %, from 3 wt. % to 5 wt. %, from 3 wt. % to 4 wt. %, or from 4 wt. % to 5 wt. % of the shape selective zeolite, based on the total weight of the slurry.

In embodiments, the slurry may comprise of from 0.5 wt. % to 4 wt. % of the basic compound, based on the total weight of the slurry. For instance, the slurry may comprise from 0.5 wt. % to 4 wt. %, from 0.5 wt. % to 3 wt. %, from 0.5 wt. % to 2 wt. %, from 0.5 wt. % to 1 wt. %, from 1 wt. % to 4 wt. %, from 1 wt. % to 3 wt. %, from 1 wt. % to 2 wt. %, from 2 wt. % to 4 wt. %, or from 2 wt. % to 3 wt. % of the basic compound, based on the total weight of the slurry.

In embodiments, the slurry may comprise of from 5 wt. % to 40 wt. % of the silica particles, based on the total weight of the slurry. For instance, the slurry may comprise from 5 wt. % to 30 wt. %, from 5 wt. % to 20 wt. %, from 10 wt. % to 40 wt. %, from 10 wt. % to 30 wt. %, from 10 wt. % to 20 wt. %, or from 15 wt. % to 25 wt. % of the silica particles, based on the total weight of the slurry.

In embodiments, the slurry may comprise of from 0.5 wt. % to 3 wt. % of the templating agent, based on the total weight of the slurry. For instance, the slurry may comprise from 0.5 wt. % to 3 wt. %, from 0.5 wt. % to 2 wt. %, from 0.5 wt. % to 1 wt. %, from 1 wt. % to 3 wt. %, from 1 wt. % to 2 wt. %, or from 2 wt. % to 3 wt. % of the templating agent, based on the total weight of the slurry.

As described herein, at block 106, the method may include hydrothermally treating the slurry to form a hydrothermal product. As used herein, “hydrothermally treating” may refer to heating a material in the presence of steam and less than 2 wt. % oxygen. In embodiments, the hydrothermal treatment may produce self-generated steam from water contained in the slurry. In other embodiments, additional moisture may be applied during the hydrothermal treatment.

In embodiments, hydrothermally treating the slurry may include heating the slurry at a temperature of greater than or equal to 100° C., such as greater than or equal to 125° C., greater than or equal to 150° C., or even greater than or equal to 170° C. In embodiments, hydrothermally treating the slurry may include heating the slurry at a temperature of from 100° C. to 200° C. Without intending to be bound by any particular theory, it is believed that heating the slurry at a temperature greater than 200° C. may change the phase of the shape selective zeolite or affect the shape and/or size of the shape selective zeolite.

In embodiments, hydrothermally treating the slurry may include heating the slurry for a duration of greater than or equal to 1 hour (hr), such as greater than or equal to 3 hr, greater than or equal to 6 hr, greater than or equal to 12 hr, greater than or equal to 24 hr, or greater than or equal to 48 hr. In embodiments, hydrothermally treating the slurry may include heating the slurry for a duration of from 1 hr to 5 days.

In embodiments, the hydrothermal product may be extracted from the slurry after hydrothermal treatment. Methods known in the art may be used to extract the hydrothermal product, such as but not limited to vacuum filtration. After extracting, the hydrothermal product may be washed with a solution, such as water.

As described herein, at block 108, the method may include calcining the hydrothermal product to form a zeolite product. In embodiments, calcining the hydrothermal product may comprise heating the hydrothermal product to a temperature of greater than or equal to 400° C., such as greater than or equal to 450° C., greater than or equal to 475° C., or greater than or equal to 500° C. In embodiments, calcining the hydrothermal product may comprise heating the hydrothermal product to a temperature of from 400° C. to 700° C., such as from 400° C. to 600° C., from 500° C. to 700° C., or from 500° C. to 600° C.

In embodiments, calcining the hydrothermal product may include heating the hydrothermal product for a duration of greater than or equal to 10 min, greater than or equal to 30 min, or greater than or equal to 2 hr. In embodiments, calcining the hydrothermal product may comprise heating the hydrothermal product for a duration of from 10 min to 12 hr, such as 6 hr.

In embodiments, the zeolite product may be subjected to an ion exchange process. In embodiments, the zeolite product may be subjected an ion exchange process by contacting the zeolite product with a solution comprising ammonium nitrate (NH₄NO₃) or ammonium acetate.

In embodiments where the zeolite product is subjected to the ion exchange process, the zeolite product may be calcined after the ion exchange process.

In embodiments, calcining the zeolite product may comprise heating the zeolite product to a temperature of greater than or equal to 400° C., such as greater than or equal to 450° C., or greater than or equal to 475° C. In embodiments, calcining the zeolite product may comprise heating the zeolite product to a temperature of from 400° C. to 700° C., such as from 400° C. to 600° C., or from 400° C. to 550° C.

In embodiments, calcining the zeolite product may comprise heating the zeolite product for a duration of greater than or equal to 10 min, greater than or equal to 30 min, or greater than or equal to 2 hr. In embodiments, calcining the zeolite product may comprise heating the zeolite product for a duration of from 10 min to 6 hr.

As described herein, at block 110, the method may include combining the zeolite product and at least one metal precursor, wherein the at least one metal precursor may comprise a manganese precursor, a phosphorous precursor, or both a manganese precursor and a phosphorous precursor, to form a zeolite composition comprising manganese, phosphorus, or both manganese and phosphorous.

In embodiments, the combining of the zeolite product and the at least one metal precursor may include impregnation of at least one metal from the at least one metal precursor in the zeolite product. In embodiments, the impregnation can include wet impregnation, or ion impregnation, among others.

In embodiments, the manganese precursor may be any compound comprising manganese, such as manganese (II) chloride tetrahydrate and manganese (II) nitrate. In embodiments, the phosphorous precursor may be any compound comprising phosphorous, such as orthophosphoric acid and monophosphoric acid.

In embodiments, the at least one metal may be oxidized in the zeolite composition. For instance, the zeolite composition may comprise a manganese oxide, such as MnO, Mn₂O₃, MnO₂, MnO₃, or Mn₂O₇. The zeolite composition may comprise phosphorous as a phosphorous oxide, such as phosphorous pentaoxide (P₂O₅).

In embodiments, the zeolite composition may comprise manganese in an amount of from 0 wt. % to 5 wt. %, such as from 1 wt. % to 5 wt. %, from 1 wt. % to 4 wt. %, from 1 wt. % to 3 wt. %, or from 1 wt. % to 2 wt. %, based on the total weight of the zeolite composition. As used herein, the wt. % of manganese refers to the wt. % of manganese metal in the zeolite composition. The wt. % of manganese metal in the zeolite composition may be determined using methods known in the art, such as inductively coupled plasma (ICP) analysis or atomic absorption spectroscopy.

In embodiments, the zeolite composition may comprise phosphorous in an amount of from 0 wt. % to 5 wt. %, such as from 1 wt. % to 5 wt. %, from 1 wt. % to 4 wt. %, from 1 wt. % to 3 wt. %, or from 1 wt. % to 2 wt. %, based on the total weight of the zeolite composition. As used herein, the wt. % of phosphorous refers to the wt. % of phosphorous metal in the zeolite composition. The wt. % of phosphorous metal in the zeolite composition may be determined using methods known in the art, such as inductively coupled plasma (ICP) analysis or atomic absorption spectroscopy.

In embodiments, the zeolite composition may have a surface area of greater than or equal to 100 m²/g, such as greater than or equal to 150 m²/g, greater than or equal to 175 m²/g, greater than or equal to 200 m²/g, greater than or equal to 225 m²/g, greater than or equal to 250 m²/g, or even greater than or equal to 255 m²/g. In embodiments, the zeolite composition may have a surface area of from 100 m²/g to 400 m²/g. For instance, in embodiments, the zeolite composition may have a surface area of from 150 m²/g to 400 m²/g, from 200 m²/g to 400 m²/g, from 225 m²/g to 400 m²/g, from 250 m²/g to 400 m²/g, from 255 m²/g to 400 m²/g, from 100 m²/g to 300 m²/g, from 150 m²/g to 300 m²/g, from 200 m²/g to 300 m²/g, from 225 m²/g to 300 m²/g, from 250 m²/g to 300 m²/g, or from 255 m²/g to 300 m²/g. The surface area is determined using BET analysis.

In embodiments, the zeolite composition may have an average mesopore volume of greater than or equal to 0.05 cm³/g, such as greater than or equal to 0.06 cm³/g, greater than or equal to 0.07 cm³/g, greater than or equal to 0.08 cm³/g, greater than or equal to 0.09 cm³/g, greater than or equal to 0.10 cm³/g, greater than or equal to 0.11 cm³/g, greater than or equal to 0.12 cm³/g, greater than or equal to 0.13 cm³/g, greater than or equal to 0.14 cm³/g, or greater than or equal to 0.15 cm³/g. In embodiments, the zeolite composition may have an average mesopore volume of from 0.05 cm³/g to 2.0 cm³/g. For instance, in embodiments, the zeolite composition may have an average mesopore volume of from 0.06 cm³/g to 3.0 cm³/g, from 0.07 cm³/g to 3.0 cm³/g, from 0.08 cm³/g to 3.0 cm³/g, from 0.09 cm³/g to 3.0 cm³/g, from 0.10 cm³/g to 3.0 cm³/g, from 0.11 cm³/g to 3.0 cm³/g, from 0.12 cm³/g to 3.0 cm³/g, from 0.13 cm³/g to 3.0 cm³/g, from 0.14 cm³/g to 3.0 cm³/g, from 0.15 cm³/g to 3.0 cm³/g, from 0.05 cm³/g to 2.0 cm³/g, from 0.06 cm³/g to 2.0 cm³/g, from 0.07 cm³/g to 2.0 cm³/g, from 0.08 cm³/g to 2.0 cm³/g, from 0.09 cm³/g to 2.0 cm³/g, from 0.10 cm³/g to 2.0 cm³/g, from 0.11 cm³/g to 2.0 cm³/g, from 0.12 cm³/g to 2.0 cm³/g, from 0.13 cm³/g to 2.0 cm³/g, from 0.14 cm³/g to 2.0 cm³/g, or from 0.15 cm³/g to 2.0 cm³/g. The average pore volume is determined using BJH analysis.

In embodiments, the zeolite composition may have an average micropore volume of greater than or equal to 0.05 cm³/g, such as greater than or equal to 0.06 cm³/g, greater than or equal to 0.07 cm³/g, greater than or equal to 0.08 cm³/g, greater than or equal to 0.09 cm³/g, or greater than or equal to 0.10 cm³/g. In embodiments, the zeolite composition may have an average micropore volume of from 0.05 cm³/g to 2.0 cm³/g. For instance, in embodiments, the zeolite composition may have an average micropore volume of from 0.06 cm³/g to 2.0 cm³/g, from 0.07 cm³/g to 2.0 cm³/g, from 0.08 cm³/g to 2.0 cm³/g, from 0.09 cm³/g to 2.0 cm³/g, from 0.10 cm³/g to 2.0 cm³/g, from 0.05 cm³/g to 1.5 cm³/g, from 0.06 cm³/g to 1.5 cm³/g, from 0.07 cm³/g to 1.5 cm³/g, from 0.08 cm³/g to 1.5 cm³/g, from 0.09 cm³/g to 1.5 cm³/g, or from 0.10 cm³/g to 1.5 cm³/g. The average micropore volume is determined using BJH analysis.

In embodiments, the zeolite composition may have an average total pore volume of greater than or equal to 0.10 cm³/g, such as greater than or equal to 0.15 cm³/g, greater than or equal to 0.20 cm³/g, greater than or equal to 0.25 cm³/g, or greater than or equal to 0.30 cm³/g. In embodiments, the zeolite composition may have an average total pore volume of from 0.1 cm³/g to 0.5 cm³/g. For instance, in embodiments, the zeolite composition may have an average total pore volume of from 0.2 cm³/g to 0.5 cm³/g, or from 0.3 cm³/g to 0.5 cm³/g. The average total pore volume is determined using BJH analysis.

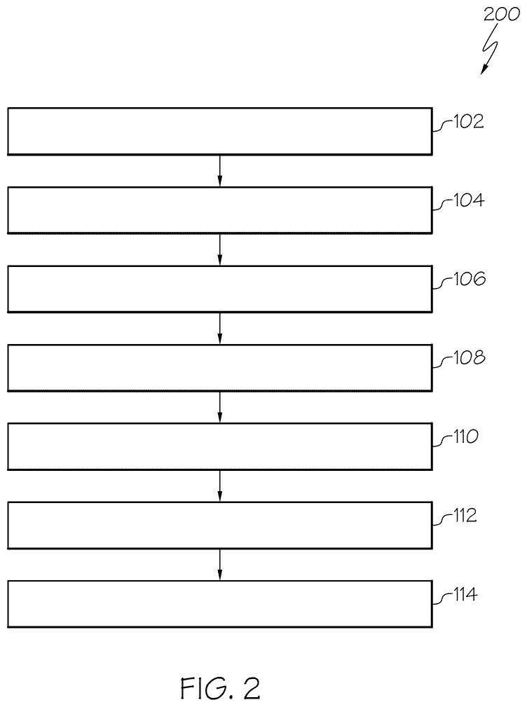

Turning now to FIG. 2, a method 200 of forming a catalyst composition is depicted. As depicted, FIG. 2 includes a series of “blocks” which are each representative of one or more steps in the processes presently described. Generally, the process steps, indicated and sometimes referred to as blocks herein, are ordered as depicted in FIG. 2. In addition to the steps described herein in reference to method 100, method 200 may include forming a catalyst precursor comprising the zeolite composition, kaolin clay, and alumina (at block 112) and drying the catalyst precursor to form the catalyst compositions (at block 114).

As described herein, at block 112, the method may include forming a catalyst precursor comprising the zeolite composition, kaolin clay, and alumina. In embodiments, the catalyst precursor may be formed by combining at least the zeolite composition, kaolin clay, and alumina in any combination and in any order.

In embodiments, the alumina may be treated with an acid, such as formic acid. That is, the catalyst precursor may further comprise the acid, or the alumina may be treated with the acid before forming the catalyst precursor. Without intending to be bound by any particular theory, it is believed that treating the alumina with the acid may peptize the alumina, adding increased physical integrity to the catalyst compositions presently described. The acid may decompose during calcination. In embodiments, the acid combined with the alumina may be any acid. In embodiments, the acid may be a monoprotic acid. In embodiments, the acid may be formic acid, nitric acid (HNO₃), or hydrochloric acid (HCl).

In embodiments, the catalyst precursor may comprise from 10 wt. % to 60 wt. % of the zeolite composition, based on the total weight of the catalyst precursor. For instance, the catalyst precursor may comprise from 10 wt. % to 50 wt. %, from 10 wt. % to 40 wt. %, from 10 wt. % to 30 wt. %, from 10 wt. % to 20 wt. %, from 20 wt. % to 60 wt. %, from 20 wt. % to 50 wt. %, from 20 wt. % to 40 wt. %, from 20 wt. % to 30 wt. %, from 30 wt. % to 60 wt. %, from 30 wt. % to 50 wt. %, from 30 wt. % to 40 wt. %, from 40 wt. % to 60 wt. %, from 40 wt. % to 50 wt. %, or from 50 wt. % to 60 wt. % of the zeolite composition, based on the total weight of the catalyst precursor.

In embodiments, the catalyst precursor may comprise from 10 wt. % to 90 wt. % of the kaolin clay, based on the total weight of the catalyst precursor. For instance, the catalyst precursor may comprise from 10 wt. % to 80 wt. %, from 10 wt. % to 70 wt. %, from 10 wt. % to 60 wt. %, from 10 wt. % to 50 wt. %, from 10 wt. % to 40 wt. %, from 10 wt. % to 30 wt. %, from 10 wt. % to 20 wt. %, from 20 wt. % to 90 wt. %, from 20 wt. % to 80 wt. %, from 20 wt. % to 70 wt. %, from 20 wt. % to 60 wt. %, from 20 wt. % to 50 wt. %, from 20 wt. % to 40 wt. %, from 20 wt. % to 30 wt. %, from 30 wt. % to 90 wt. %, from 30 wt. % to 80 wt. %, from 30 wt. % to 70 wt. %, from 30 wt. % to 60 wt. %, from 30 wt. % to 50 wt. %, from 30 wt. % to 40 wt. %, from 40 wt. % to 90 wt. %, from 40 wt. % to 80 wt. %, from 40 wt. % to 70 wt. %, from 40 wt. % to 60 wt. %, from 40 wt. % to 50 wt. %, from 50 wt. % to 90 wt. %, from 50 wt. % to 80 wt. %, from 50 wt. % to 70 wt. %, from 50 wt. % to 60 wt. %, from 60 wt. % to 90 wt. %, from 60 wt. % to 80 wt. %, from 60 wt. % to 70 wt. %, from 70 wt. % to 90 wt. %, from 70 wt. % to 80 wt. %, or from 80 wt. % to 90 wt. % of the kaolin clay, based on the total weight of the catalyst precursor.

In embodiments, the catalyst precursor may comprise from 10 wt. % to 30 wt. % of the alumina, based on the total weight of the catalyst precursor. For instance, the catalyst precursor may comprise from 10 wt. % to 25 wt. %, from 10 wt. % to 20 wt. %, from 10 wt. % to 15 wt. %, from 15 wt. % to 30 wt. %, from 15 wt. % to 25 wt. %, from 15 wt. % to 20 wt. %, from 20 wt. % to 30 wt. %, from 20 wt. % to 25 wt. %, or from 25 wt. % to 30 wt. % of the alumina, based on the total weight of the catalyst precursor.

As described herein, at block 114, the method may include drying and calcining the catalyst precursor to form the catalyst composition. As used in this disclosure, a “catalyst composition” refers to any substance that increases the rate of a specific chemical reaction. Catalyst compositions described in this disclosure may be utilized to promote various reactions, such as, but not limited to, cracking of a hydrocarbon feedstream. In embodiments, the drying may include spray drying the catalyst precursor.

In embodiments, the catalyst composition may have an average widest length of from 20 microns to 100 microns. The average widest length of the catalyst composition may be determined using electron microscopy, such as but not limited to, transmission electron microscopy or scanning electron microscopy, to measure the widest length of individual particles in a sample and averaging the widest length of the individual particles.

In embodiments, the catalyst precursor may be calcined after drying. In embodiments, calcining the catalyst precursor may comprise heating the catalyst precursor to a temperature of greater than or equal to 400° C., such as greater than or equal to 450° C., or greater than or equal to 475° C. In embodiments, calcining the catalyst precursor may comprise heating the catalyst precursor to a temperature of from 400° C. to 700° C., such as from 400° C. to 600° C., from 500° C. to 700° C., or from 500° C. to 600° C.

In embodiments, calcining the catalyst precursor may comprise heating the catalyst precursor for a duration of greater than or equal to 10 min, greater than or equal to 30 min, or greater than or equal to 2 hr. In embodiments, calcining the catalyst precursor may comprise heating the catalyst precursor for a duration of from 10 min to 10 days.

In embodiments, the catalyst composition may have a surface area of greater than or equal to 100 m²/g, such as greater than or equal to 150 m²/g, greater than or equal to 175 m²/g, greater than or equal to 200 m²/g, greater than or equal to 225 m²/g, greater than or equal to 250 m²/g, or even greater than or equal to 255 m²/g. In embodiments, the catalyst composition may have a surface area of from 100 m²/g to 500 m²/g. For instance, in embodiments, the catalyst composition may have a surface area of from 150 m²/g to 500 m²/g, from 200 m²/g to 500 m²/g, from 250 m²/g to 500 m²/g, from 300 m²/g to 500 m²/g, or from 350 m²/g to 500 m²/g. The surface area is determined using BET analysis.

In embodiments, the catalyst composition may have an average mesopore volume of greater than or equal to 0.05 cm³/g, such as greater than or equal to 0.06 cm³/g, greater than or equal to 0.07 cm³/g, greater than or equal to 0.08 cm³/g, greater than or equal to 0.09 cm³/g, greater than or equal to 0.10 cm³/g, greater than or equal to 0.11 cm³/g, greater than or equal to 0.12 cm³/g, greater than or equal to 0.13 cm³/g, greater than or equal to 0.14 cm³/g, or greater than or equal to 0.15 cm³/g. In embodiments, the catalyst composition may have an average mesopore volume of from 0.05 cm³/g to 2.0 cm³/g. For instance, in embodiments, the catalyst composition may have an average mesopore volume of from 0.06 cm³/g to 3.0 cm³/g, from 0.07 cm³/g to 3.0 cm³/g, from 0.08 cm³/g to 3.0 cm³/g, from 0.09 cm³/g to 3.0 cm³/g, from 0.10 cm³/g to 3.0 cm³/g, from 0.11 cm³/g to 3.0 cm³/g, from 0.12 cm³/g to 3.0 cm³/g, from 0.13 cm³/g to 3.0 cm³/g, from 0.14 cm³/g to 3.0 cm³/g, from 0.15 cm³/g to 3.0 cm³/g, from 0.05 cm³/g to 2.0 cm³/g, from 0.06 cm³/g to 2.0 cm³/g, from 0.07 cm³/g to 2.0 cm³/g, from 0.08 cm³/g to 2.0 cm³/g, from 0.09 cm³/g to 2.0 cm³/g, from 0.10 cm³/g to 2.0 cm³/g, from 0.11 cm³/g to 2.0 cm³/g, from 0.12 cm³/g to 2.0 cm³/g, from 0.13 cm³/g to 2.0 cm³/g, from 0.14 cm³/g to 2.0 cm³/g, or from 0.15 cm³/g to 2.0 cm³/g. The average pore volume is determined using BJH analysis.

In embodiments, the catalyst composition may have an average micropore volume of greater than or equal to 0.05 cm³/g, such as greater than or equal to 0.06 cm³/g, greater than or equal to 0.07 cm³/g, greater than or equal to 0.08 cm³/g, greater than or equal to 0.09 cm³/g, or greater than or equal to 0.10 cm³/g. In embodiments, the catalyst composition may have an average micropore volume of from 0.05 cm³/g to 2.0 cm³/g. For instance, in embodiments, the catalyst composition may have an average micropore volume of from 0.06 cm³/g to 2.0 cm³/g, from 0.07 cm³/g to 2.0 cm³/g, from 0.08 cm³/g to 2.0 cm³/g, from 0.09 cm³/g to 2.0 cm³/g, from 0.10 cm³/g to 2.0 cm³/g, from 0.09 cm³/g to 2.0 cm³/g, from 0.10 cm³/g to 2.0 cm³/g, from 0.11 cm³/g to 2.0 cm³/g, from 0.12 cm³/g to 2.0 cm³/g, from 0.13 cm³/g to 2.0 cm³/g, from 0.14 cm³/g to 2.0 cm³/g, or from 0.15 cm³/g to 2.0 cm³/g. The average micropore volume is determined using BJH analysis.

In embodiments, the catalyst composition may have an average total pore volume of greater than or equal to 0.10 cm³/g, such as greater than or equal to 0.15 cm³/g, greater than or equal to 0.20 cm³/g, greater than or equal to 0.25 cm³/g, or greater than or equal to 0.30 cm³/g. In embodiments, the catalyst composition may have an average total pore volume of from 0.1 cm³/g to 0.5 cm³/g. For instance, in embodiments, the catalyst composition may have an average total pore volume of from 0.2 cm³/g to 0.5 cm³/g, or from 0.3 cm³/g to 0.5 cm³/g. The average total pore volume is determined using BJH analysis.

In embodiments, zeolite compositions and catalyst compositions comprising zeolite compositions as described herein may be used in methods of cracking hydrocarbon feed streams. As used in this disclosure, “cracking” generally refers to a chemical reaction where carbon-carbon bonds are broken. For example, a molecule having carbon to carbon bonds is broken into more than one molecule by the breaking of one or more of the carbon to carbon bonds, or is converted from a compound which includes a cyclic moiety, such as a cycloalkane, cycloalkane, naphthalene, an aromatic or the like, to a compound which does not include a cyclic moiety or contains fewer cyclic moieties than prior to cracking.

In embodiments, the method of cracking a hydrocarbon feed stream may include contacting the hydrocarbon feed stream with one or more of the zeolite compositions or catalyst compositions described herein in a reactor to crack at least a portion of the hydrocarbon feed stream to form a product effluent. It should be understood that a “product effluent” generally refers to a stream that exits a system component such as a reactor or reactor zone, following a particular reaction, and generally has a different composition (at least proportionally) than the stream that entered the reactor or reaction zone, such as the hydrocarbon feed stream.

In embodiments, the hydrocarbon feedstream may be a crude oil. As used in the present disclosure, the term “crude oil” refers to a mixture of petroleum liquids and gases, including impurities, such as sulfur-containing compounds, nitrogen-containing compounds, and metal compounds, extracted directly from a subterranean formation or received from a desalting unit without having any fractions, such as naphtha, separated by distillation. In other embodiments, the crude oil may be processed, such as separated by distillation, and the hydrocarbon feedstream may comprise a processed stream of the crude oil.

In embodiments, the hydrocarbon feedstream may comprise from 10 wt. % to 70 wt. % naphtha, based on the total weight of the hydrocarbon feedstream. For instance, in embodiments, the hydrocarbon feedstream may comprise from 10 wt. % to 60 wt. %, from 10 wt. % to 50 wt. %, from 10 wt. % to 40 wt. %, from 10 wt. % to 30 wt. %, from 10 wt. % to 20 wt. %, from 20 wt. % to 70 wt. %, from 20 wt. % to 60 wt. %, from 20 wt. % to 50 wt. %, from 20 wt. % to 40 wt. %, from 20 wt. % to 30 wt. %, from 30 wt. % to 70 wt. %, from 30 wt. % to 60 wt. %, from 30 wt. % to 50 wt. %, from 30 wt. % to 40 wt. %, from 40 wt. % to 70 wt. %, from 40 wt. % to 60 wt. %, from 40 wt. % to 50 wt. %, from 50 wt. % to 70 wt. %, from 50 wt. % to 60 wt. %, or from 60 wt. % to 70 wt. % naphtha, based on the total weight of the hydrocarbon feedstream. As used in the present disclosure, the term “naphtha” refers to an intermediate mixture of hydrocarbon-containing materials derived from crude oil refining and having atmospheric boiling points from 25 degrees Celsius (° C.) to 220° C.

In embodiments, the hydrocarbon feedstream may comprise from 20 wt. % to 60 wt. % middle distillates, based on the total weight of the hydrocarbon feedstream. For instance, the hydrocarbon feedstream may comprise from 20 wt. % to 50 wt. %, from 20 wt. % to 40 wt. %, or from 20 wt. % to 30 wt. % middle distillates, based on the total weight of the hydrocarbon feedstream. As used in the present disclosure, the term “middle distillates” refers to an intermediate mixture of hydrocarbon-containing materials derived from crude oil refining and having atmospheric boiling points from 221° C. to 343° C.

In embodiments, the hydrocarbon feedstream may comprise from 10 wt. % to 70 wt. % heavy distillates, based on the total weight of the hydrocarbon feedstream. For instance, in embodiments, the hydrocarbon feedstream may comprise from 10 wt. % to 60 wt. %, from 10 wt. % to 50 wt. %, from 10 wt. % to 40 wt. %, from 10 wt. % to 30 wt. %, from 10 wt. % to 20 wt. %, from 20 wt. % to 70 wt. %, from 20 wt. % to 60 wt. %, from 20 wt. % to 50 wt. %, from 20 wt. % to 40 wt. %, from 20 wt. % to 30 wt. %, from 30 wt. % to 70 wt. %, from 30 wt. % to 60 wt. %, from 30 wt. % to 50 wt. %, from 30 wt. % to 40 wt. %, from 40 wt. % to 70 wt. %, from 40 wt. % to 60 wt. %, from 40 wt. % to 50 wt. %, from 50 wt. % to 70 wt. %, from 50 wt. % to 60 wt. %, or from 60 wt. % to 70 wt. % heavy distillates, based on the total weight of the hydrocarbon feedstream. As used in the present disclosure, the term “heavy distillates” refers to an intermediate mixture of hydrocarbon-containing materials derived from crude oil refining and having atmospheric boiling points of greater than 343° C.

As used in this disclosure, a “reactor” refers to a vessel in which one or more chemical reactions may occur between one or more reactants optionally in the presence of one or more catalysts. For example, a reactor may include a tank or tubular reactor configured to operate as a batch reactor, a continuous stirred-tank reactor (CSTR), or a plug flow reactor. Example reactors include packed bed reactors such as fixed bed reactors, and fluidized bed reactors. One or more “reaction zones” may be disposed in a reactor. As used in this disclosure, a “reaction zone” refers to an area where a particular reaction takes place in a reactor. For example, a packed bed reactor with multiple catalyst beds may have multiple reaction zones, where each reaction zone is defined by the area of each catalyst bed.

In embodiments, the reactor may be operated at a weight hourly space velocity (WHSV) of from 0.1 h⁻¹ to 25 h⁻¹. As used in the present disclosure, the “WHSV” is defined as the weight of the hydrocarbon feed flowing into the reactor per unit weight of the catalyst composition in the reactor per hour. For instance, in embodiments, the reactor may be operated at a weight hourly space velocity (WHSV) of from 0.1 h⁻¹ to 20 h⁻¹, from 0.1 h⁻¹ to 10 h⁻¹, from 0.1 h⁻¹ to 5 h⁻¹, from 1 h⁻¹ to 25 h⁻¹, from 1 h⁻¹ to 20 h⁻¹, from 1 h⁻¹ to 10 h⁻¹, from 1 h⁻¹ to 5 h⁻¹, from 2 h⁻¹ to 25 h⁻¹, from 2 h⁻¹ to 20 h⁻¹, from 2 h⁻¹ to 10 h⁻¹, from 2 h⁻¹ to 5 h⁻¹, or from 2 h⁻¹ to 4 h⁻¹.

In embodiments, the reactor may be operated at a temperature of from 500° C. to 700° C., such as from 550° C. to 700° C., from 600° C. to 700° C., or from 650° C. to 700° C.

In embodiments, the product effluent may comprise greater than or equal to 20 wt. % light olefins, based on the total weight of the product effluent. As used in this disclosure, “light olefins” refers to ethylene and propylene. For instance, the product effluent may comprise greater than or equal to 25 wt. %, greater than or equal to 30 wt. %, greater than or equal to 35 wt. %, or even greater than or equal to 37 wt. % light olefins. In embodiments, the product effluent may comprise of from 20 wt. % to 60 wt. % light olefins, such as from 20 wt. % to 50 wt. %, from 20 wt. % to 40 wt. %, from 30 wt. % to 60 wt. %, from 30 wt. % to 50 wt. %, from 30 wt. % to 40 wt. %, from 35 wt. % to 60 wt. %, from 35 wt. % to 50 wt. %, or from 35 wt. % to 40 wt. % light olefins.

Without intending to be bound by any particular theory, it is believed that the zeolite compositions and catalyst compositions described herein may be used to crack a hydrocarbon feedstream and produce a product effluent having a greater amount of light olefins compared to methods using conventional catalysts derived from kaolin clay comprising less than 10 wt. % halloysite.
A first aspect of the present disclosure is directed to a method of forming a zeolite composition, the method comprising calcining one or more clay mineral compositions to form metakaolin, wherein the one or more clay mineral compositions comprises greater than or equal to 10 wt. % halloysite, forming a slurry by combining at least the metakaolin, a shape selective zeolite, a basic compound, silica particles, and a templating agent, hydrothermally treating the slurry to form a hydrothermal product, calcining the hydrothermal product to form a zeolite product, combining the zeolite product and at least one metal precursor, wherein the at least one metal precursor comprises a manganese precursor, a phosphorous precursor, or both a manganese precursor and a phosphorous precursor to form a zeolite composition comprising manganese, phosphorus, or both manganese and phosphorous.
A second aspect of the present disclosure may include the first aspect, wherein the one or more clay mineral compositions comprise of from 50 weight percent (wt. %) to 100 wt. % halloysite.
A third aspect of the present disclosure may include either one of the first or second aspects, wherein the one or more clay mineral compositions comprise from 0 wt. % to 90 wt. % kaolinite.
A fourth aspect of the present disclosure may include any one of the first through third aspects, wherein the one or more clay mineral compositions are naturally occurring.
A fifth aspect of the present disclosure may include any one of the first through fourth aspects, wherein calcining the one or more clay mineral compositions comprises heating the one or more clay mineral compositions to a temperature of greater than or equal to 500° C.
A sixth aspect of the present disclosure may include any one of the first through fifth aspects, wherein the metakaolin has an average surface area of greater than 30 m²/g.
A seventh aspect of the present disclosure may include any one of the first through sixth aspects, wherein the metakaolin has an average pore volume of greater than 0.15 cm³/g.
An eighth aspect of the present disclosure may include any one of the first through seventh aspects, wherein the templating agent comprises an ammonium salt, a poloxamer, or combinations thereof.
A ninth aspect of the present disclosure may include any one of the first through eighth aspects, wherein hydrothermally treating the slurry includes heating the slurry at a temperature of greater than or equal to 100° C.
A tenth aspect of the present disclosure may include any one of the first through ninth aspects, wherein calcining the hydrothermal product comprises heating the hydrothermal product to a temperature of greater than or equal to 400° C.
An eleventh aspect of the present disclosure may include any one of the first through tenth aspects, wherein the zeolite product is subjected to an ion-exchange process.
A twelfth aspect of the present disclosure may include any one of the first through eleventh aspects, wherein the combining the zeolite product and the metal precursor comprises impregnating a metal from the metal precursor in the zeolite product.
A thirteenth aspect of the present disclosure may include any one of the first through twelfth aspects, wherein the zeolite composition comprises manganese in an amount of from 0 wt. % to 5 wt. % and phosphorous in an amount of from 0 wt. % to 5 wt. %.
A fourteenth aspect of the present disclosure may include any one of the first through thirteenth aspects, wherein the shape selective zeolite is ZSM-5 zeolite.
A fifteenth aspect of the present disclosure is directed to a method of forming a catalyst composition, the method comprising calcining one or more clay mineral compositions to form metakaolin, wherein the one or more clay mineral compositions comprises greater than or equal to 10 wt. % halloysite, forming a slurry by combining at least the metakaolin, a shape selective zeolite, a basic compound, silica particles, and a templating agent, hydrothermally treating the slurry to form a hydrothermal product, calcining the hydrothermal product to form a zeolite product, combining the zeolite product and at least one metal precursor, wherein the at least one metal precursor comprises a manganese precursor, a phosphorous precursor, or both a manganese precursor and a phosphorous precursor to form a zeolite composition comprising manganese, phosphorus, or both manganese and phosphorous, forming a catalyst precursor comprising the zeolite composition, kaolin clay, and alumina, and drying and calcining the catalyst precursor to form the catalyst composition.
A sixteenth aspect of the present disclosure may include the fifteenth aspect, wherein the alumina is treated with an acid before the combining.
A seventeenth aspect of the present disclosure may include the fifteenth aspect or sixteenth aspect, wherein the catalyst precursor comprises from 10 wt. % to 60 wt. % of the zeolite composition, based on the total weight of the catalyst precursor.
An eighteenth aspect of the present disclosure may include any one of the fifteenth through seventeenth aspects, wherein drying the catalyst precursor includes spray drying the catalyst precursor to form the catalyst composition.
A nineteenth aspect of the present disclosure may include a method of cracking a hydrocarbon feed stream comprising contacting the hydrocarbon feed stream with a material comprising the zeolite composition of any one of the first through eighteenth aspects in a reactor to crack at least a portion of the hydrocarbon feedstream to form a product effluent comprising olefins.
A twentieth aspect of the present disclosure may include the nineteenth aspect, wherein the hydrocarbon feed stream is crude oil.

### EXAMPLES

The various embodiments disclosed herein will be further clarified by the following examples. The examples are illustrative in nature, and should not be understood to limit the embodiments disclosed herein.

### Comparative Example A. Preparation of Metakaolin from Kaolinite

In Comparative Example A, metakaolin was prepared by calcining kaolin clay comprising hydrated aluminium silicate (kaolinite). The kaolin clay of Comparative Example A is commercially available as Kaolin (K7375) from Sigma Aldrich. Metakaolin was formed by heating the kaolin clay in an oven at a ramp rate of 5° C./min until reaching 700° C. The sample was calcined for 2 hours at 700° C. to form metakaolin, denoted as Comparative Example A.

### Example 1. Preparation of Metakaolin from Halloysite

In Example 1, metakaolin was prepared by calcining a kaolin clay comprising halloysite. In Examples 1-1, 1-2, and 1-3, the calcining time was varied.

### Example 1-1

To prepare Example 1-1, kaolin clay comprising halloysite was calcined. The kaolin clay of Example 1 is commercially available as halloysite nanoclay (685445) from Sigma Aldrich. Metakaolin was formed by heating naturally occurring kaolin clay comprising halloysite in an oven at a ramp rate of 5° C./min until reaching 700° C. The sample was calcined for 30 min at 700° C. to form metakaolin, denoted as Example 1-1.

### Example 1-2

Example 1-2 was prepared according to Example 1-1, but the sample was calcined for 1 hour at 700° C. to form metakaolin, denoted as Example 1-2.

### Example 1-3

Example 1-3 was prepared according to Example 1-1, but the sample was calcined for 2 hour at 700° C. to form metakaolin, denoted as Example 1-3.

### Comparative Example B. Preparation of ZSM-5 Zeolite from Kaolinite

In Comparative Example B. ZSM-5 zeolites were prepared using metakaolin formed from kaolinite. In particular, metakaolin was formed according to Comparative Example A.

### Comparative Example B-1

To prepare Comparative Example B-1, an alkaline mixture was prepared by mixing 10 mL of distilled water and 1 gram of sodium hydroxide (NaOH), which was stirred for 20 min. Comparative Example A (1.0 g) was dispersed in deionized water (10 ml) and stirred for 1 hour to form a metakaolin dispersion. The metakaolin dispersion was mixed with the alkaline mixture to form a metakaolin alkaline mixture. Silica particles (22.83 g, Ludox® AS-40 colloidal silica, (Cat. No. 420840, Sigma Aldrich) were added dropwise to the metakaolin alkaline mixture and stirred for 1 hour to form a metakaolin-nanosilica mixture. The metakaolin-nanosilica mixture was dispersed in deionized water (10 mL) and stirred for 16 hours. An initial ZSM-5 zeolite having a silica to alumina ratio (SAR) of 80 (0.09 g, Product No. CBV 8014, Zeolyst International) was added to the metakaolin-nanosilica solution mixture to act as seeds that facilitated the zeolite growth, and was stirred for 2 hours. Tetrapropylammonium bromide (TPABr) (0.5 g) was added to the seeded metakaolin-nanosilica mixture to form the slurry, and the slurry was kept at room temperature and not stirred for 12 hours. The slurry was transferred to a Teflon-lined autoclave and aged at 175° C. for 72 hours to obtain the kaolinite-based zeolite. The kaolinite-based zeolite was extracted from the solution by vacuum filtration washed three times with deionized water, and then dried at 100° C. for 12 h. The washed and dried zeolite was calcined at 550° C. for 6 hours. The calcined zeolite was ion exchanged twice using 10 mL of 1M NH₄NO₃ solution per gram of zeolite at 80° C. for 3 hours. The ion-exchanged zeolite was washed and calcined at 500° C. for 2 hours. The final zeolite product is denoted as Comparative Example B-1.

### Comparative Example B-2

Comparative Example B-2 was prepared according to Comparative Example B-1, but the TPABr was not present in the slurry. The final zeolite is denoted as Comparative Example B-1.

### Example 2. Preparation of ZSM-5 Zeolite from Halloysite

In Example 2, ZSM-5 zeolites were prepared using metakaolin formed from halloysite. In particular, metakaolin was formed according to Example 1-3. To prepare Example 2, an alkaline mixture was prepared by mixing 10 mL of distilled water and 1 gram of sodium hydroxide (NaOH), which was stirred for 20 min. Example 1-3 (1.0 g) was dispersed in deionized water (10 ml) and stirred for 1 hour to form a metakaolin dispersion. The metakaolin dispersion was mixed with the alkaline mixture to form a metakaolin alkaline mixture. Silica particles (22.83 g, Ludox® AS-40 colloidal silica, (Cat. No. 420840, Sigma Aldrich) were added dropwise to the metakaolin alkaline mixture and stirred for 1 hour to form a metakaolin-nanosilica mixture. The metakaolin-nanosilica mixture was dispersed in deionized water (10 mL) and stirred for 16 hours. An initial ZSM-5 zeolite having a silica to alumina ratio (SAR) of 80 (0.09 g, Product No. CBV 8014, Zeolyst International) was added to the metakaolin-nanosilica solution mixture to act as seeds that facilitated the zeolite growth, and was stirred for 2 hours. Tetrapropylammonium bromide (TPABr) (0.5 g) was added to the seeded metakaolin-nanosilica mixture to form the slurry, and the slurry was kept at room temperature and not stirred for 12 hours. The slurry was transferred to a Teflon-lined autoclave and aged at 175° C. for 72 hours to obtain the kaolinite-based zeolite. The kaolinite-based zeolite was extracted from the solution by vacuum filtration washed three times with deionized water, and then dried at 100° C. for 12 h. The washed and dried zeolite was calcined at 550° C. for 6 hours. The calcined zeolite was ion exchanged twice using 10 mL of 1M NH₄NO₃ solution per gram of zeolite at 80° C. for 3 hours. The ion-exchanged zeolite was washed and calcined at 500° C. for 2 hours. The final zeolite product is denoted as Example 2.

### Comparative Example C. Preparation of Metal-Doped ZSM-5 from Kaolinite

In Comparative Example C, metal-doped ZSM-5 zeolites were prepared using metakaolin formed from kaolinite. In particular, the ZSM-5 zeolites of Comparative Example B were impregnated with manganese.

### Comparative Example C-1

To prepare Comparative Example C-1, Comparative Example B-1 was combined with a manganese precursor using a wet impregnation method. Specifically manganese chloride (2 wt. % Mn, 0.0458 g) was dissolved in 30 mL of deionized water. Thereafter, 1.0 g of Comparative Example B-1 was added to the solution and stirred until the water was almost completely evaporated. The system was allowed to dry under atmospheric condition, and was then heated in an oven for 6 h at 120° C. The product was then calcined at 650° C. for 5 h. The final zeolite comprised 2 wt. % manganese, and is denoted as Comparative Example C-1.

### Comparative Example C-2

Comparative Example C-2 was prepared according to Comparative Example C-1, but Comparative Example B-2 was combined with the manganese precursor rather than Comparative Example B-1. The final zeolite comprised 2 wt. % manganese, and is denoted as Comparative Example C-2.

### Example 3. Preparation of Metal-Doped ZSM-5 from Halloysite

In Example 3, metal-doped ZSM-5 zeolites were prepared using metakaolin formed from halloysite. In particular, the ZSM-5 zeolite of Example 2 was doped with manganese (Example 3-1) or both manganese and phosphorous (Example 3-2).

### Example 3-1

To prepare Example 3-1, Example 2 was combined with a manganese precursor using a wet impregnation method. Specifically manganese chloride (2 wt. % Mn, 0.0458 g) was dissolved in 30 mL of deionized water. Thereafter, 1.0 g of Comparative Example 2 was added to the solution and stirred until the water was almost completely evaporated. The system was allowed to dry under atmospheric condition, and was then heated in an oven for 6 h at 120° C. The product was then calcined at 650° C. for 5 h. The final zeolite comprised 2 wt. % manganese, and is denoted as Example 3-1.

### Example 3-2

To prepare Example 3-2, Example 2 was combined with a manganese precursor and phosphorus precursor. Specifically Example 3-2 was prepared according to Example 3-1 and additionally included H₃PO₄. The final zeolite comprised 1 wt. % manganese and 1 wt. % phosphorous, and is denoted as Example 3-2.

### Example 4. Preparation of Catalyst Compositions from Halloysite

In Example 4, a catalyst composition was prepared using ZSM-5 formed from halloysite. In particular, the catalyst composition of Example 4 was prepared by blending 200 g (dry basis) kaolin clay powder (Sigma Aldrich) with 431.92 g of deionized (DI water) to make a kaolin slurry. In a separate step, 200 g (dry basis) of Example 3-2 was made into a zeolite slurry with 462.59 g DI water and stirred for 10 mins. The zeolite slurry was added to the kaolin slurry and stirred for 5 mins. Separately, a slurry of Pural SB alumina, Sasol was prepared by mixing 100.0 g (dry basis) of the alumina with 194.92 g DI water and peptizing the mixture by adding 7.22 g concentrated formic acid (70 wt %) and stirring for 30 min. The resulting peptized Pural SB slurry was added to the zeolite-kaolin slurry and blended for ten minutes producing a slurry with high viscosity where the individual particles remained suspended. The resulting slurry made up of 30% solids was spray dried to produce particles of 20-100 microns. The particles were calcined at 550° C. for 6 h. The final catalyst composition is denoted as Example 4.

### Example 5. Evaluation of Metakaolin Formed from Kaolinite and Halloysite

In Example 5, the metakaolin formed in Comparative Example A and Example 1 were characterized to distinguish differences between the metakaolin based on the kaolin material calcined.

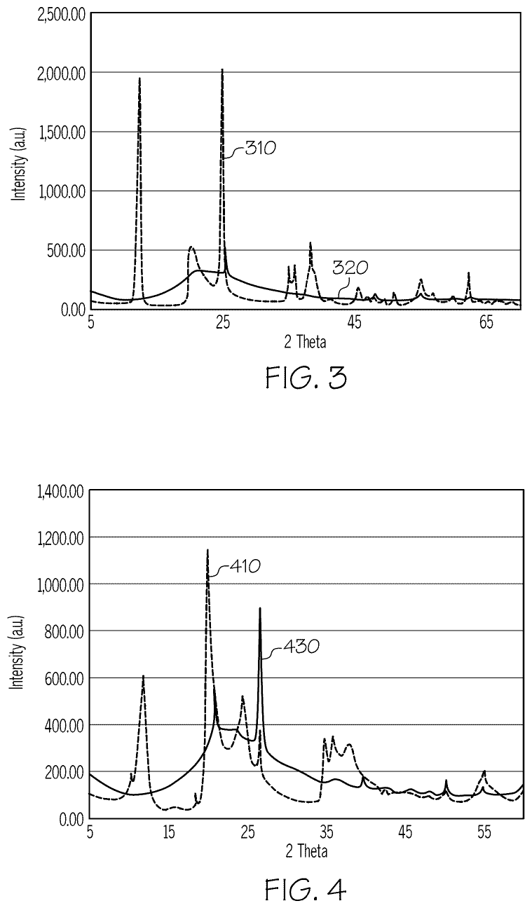

Referring to FIG. 3, X-ray diffraction (XRD) spectra of kaolin clay used in the Comparative Examples 310, and Comparative Example A (metakaolin formed therefrom) 320 are depicted. Referring to FIG. 4, X-ray diffraction (XRD) spectra of kaolin clay used in the Examples 410, and Example 1 (metakaolin formed therefrom) 420 are depicted. The characteristic peaks of kaolin clays disappeared after calcination indicating the successful conversion of kaolin clay to metakaolin. For example, FIG. 4 shows the characteristic peaks of halloysite clay at 20=11.8°, 19.9°, 24.8°, 35°, 36°, 38.3°, and 55.2°. After calcination, the characteristic peaks disappeared into a broad band with a sharp peak at 26.7°. These results show that calcining the kaolin clay (both kaolin clay of the comparative examples and kaolin clay of the Examples) leads to structural changes from crystalline kaolin clay to amorphous metakaolin.

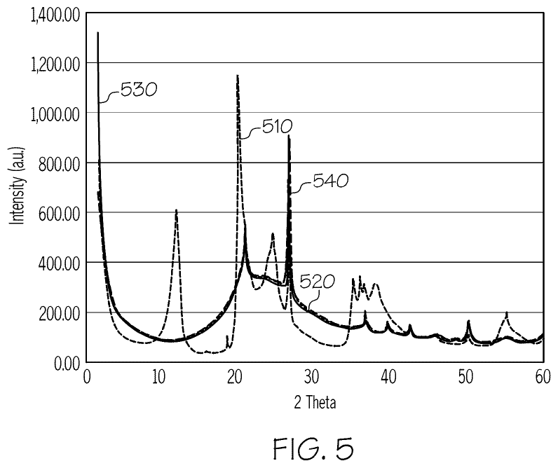

Referring to FIG. 5, X-ray diffraction (XRD) spectra of kaolin clay used in the Examples 510, and metakaolin derived therefrom of Example 1-1 520, Example 1-2 530, and Example 1-3 540 are depicted. As demonstrated in FIG. 5, the structural change of the kaolin clay 510 to metakaolin occurred after a calcination time of 30 min (Example 1-1 520).

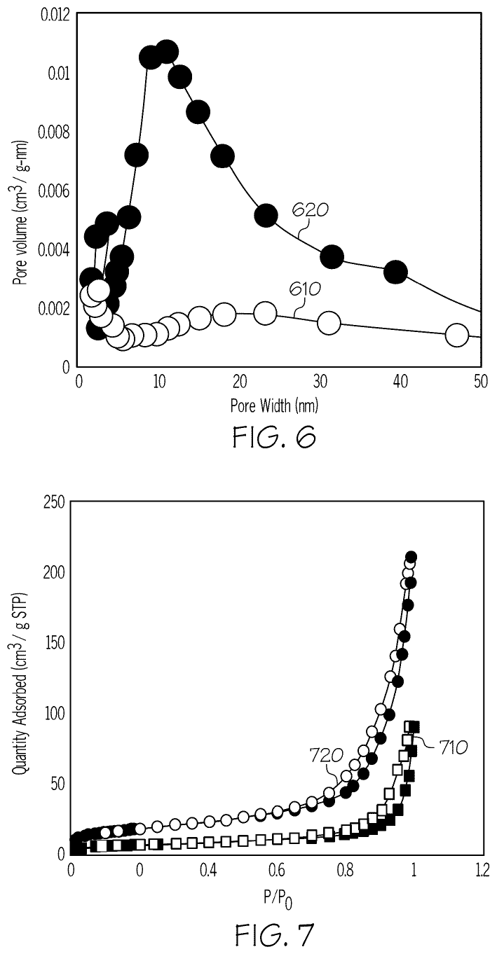

Referring to FIG. 6 and FIG. 7, the nitrogen adsorption-desorption isotherms provided the surface areas, pore volumes, and pore distributions of Comparative Example A and Example 1-3. Textural characteristics involving surface area and pore size distributions of parent and formulations were measured using an ASAP-2020 plus (Micromeritics, USA). The samples were pretreated before measurements at 523 K for 2 h. The surface area and pore sizes were calculated using BET and BJH technique. The surface area was evaluated by considering adsorption values of linear plots for BET. Pore volume was obtained at p/p0=0.98, while micropore surface area was calculated based on t-plot technique. FIG. 6 shows that Comparative Example A 610 has a pore volume of 0.11 cm³/g, whereas Example 1-3 620 had a pore volume of 0.32 cm³/g. FIG. 7 shows that Comparative Example A 710 has a surface area of 23 m²/g, whereas Example 1-3 has a surface area of 64 m²/g. Example 1-3 demonstrated meso surface characteristics with a type IV isotherm with H3 hysteresis. These results demonstrate that metakaolin formed from kaolin clay comprising halloysite provides increased surface area and pore volume in comparison to metakaolin formed from kaolin clay comprising kaolinite.

### Example 6. Evaluation of Metakaolin and ZSM-5 Zeolites Formed from Kaolinite and Halloysite

Further, the surface areas, pore volumes, and pore distributions of the Examples and Comparative Examples were measured, and summarized in Table 1. A t-plot was used to differentiate microporous and mesoporous surface area. MicroSA refers to the microporous surface area. MicroPV refers to the microporous pore volume. MesoPV refers to the mesoporous pore volume. PSD refers to the pore size distribution.

TABLE 1

| | Surface | | Pore | | | |
|---|---|---|---|---|---|---|
| | area | MicroSA | Volume | MicroPV | MesoPV | PSD |
| Sample | (m²/g) | (m²/g) | (cm³/g) | (cm³/g) | (cm³/g) | (nm) |
| Example 1 | 77 | 0.6 | 0.34 | — | 0.34 | 17.7 |
| Comparative Example A | 23 | 0.5 | 0.11 | — | 0.11 | 20.2 |
| Comparative Example B-1 | 168 | 123 | 0.18 | 0.07 | 0.11 | 4.22 |
| Comparative Example B-2 | 257 | 161 | 0.17 | 0.09 | 0.08 | 2.67 |
| Example 2 | 248 | 178 | 0.25 | 0.10 | 0.15 | 4.02 |
| Comparative Example C-2 | 279 | 179 | 0.24 | 0.10 | 0.14 | 3.46 |
| Example 3-1 | 264 | 191 | 0.21 | 0.11 | 0.10 | 3.23 |
| Example 4 | 387 | 282 | 0.34 | 0.16 | 0.18 | 3.49 |

Referring to FIG. 8, thermogravimetric analysis spectra for kaolin clay comprising kaolinite 810, kaolin clay comprising halloysite 820, Comparative Example A 830, Example 1-3 840, and Example 2 850 are depicted between 100° C. to 900° C. FIG. 8 shows that a two-stage weight loss occurred when heating the kaolinite clay 810 and the halloysite clay 820 from 100° C. to 900° C. The first-stage weight loss at a temperature below 200° C. is attributed to the desorption of water molecules. The second-stage weight loss at a temperature above 400° C. is attributed to dehydroxylation indicating the Al—OH group rearrangement and structural change during the conversion of kaolin to metakaolin. The results show that halloysite clay (820) and Example 1-3 (840) had larger weight loss (16% and 6.2%, respectively) than kaolinite clay (810) and Comparative Example A (830) (14% and 4.9%, respectively). Additionally, Example 2 (850), the zeolite synthesized from metakaolin of Example 1-3, which had a tetrapropylammonium bromide template, had a total weight loss of 8.4%. The template degradation can be observed followed by the dehydroxylation process. The results confirm that the conversion of halloysite clay to metakaolin involves unique, high structural Al—OH group rearrangement compared to the conversion of kaolinite clay.

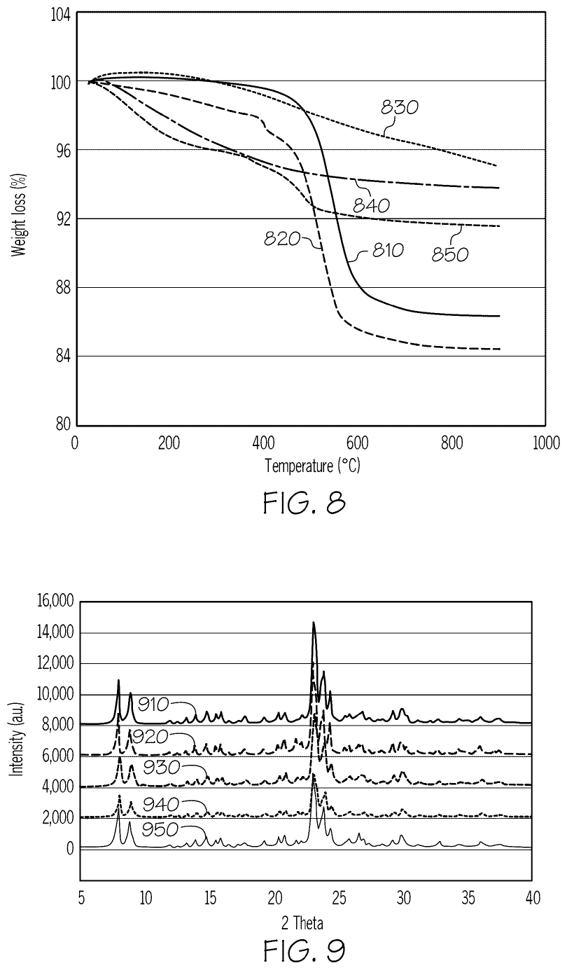

Referring to FIG. 9, XRD spectra of a ZSM-5 reference and various Comparative Examples and Examples are depicted. The crystallinity of sample was evaluated with reference to the peak height (100% of peak between 22-25°) of a commercial ZSM-5 zeolite 910 (ZSM-5-23, Zeolyst International, Cat. No. CBV 2314). FIG. 9 shows the crystallinity of Comparative Example B-1 920 and Example 2 930 were 92% and 71%, respectively. Such a reduction in crystallinity, in particular with Example 2 may be correlated to the amorphous characteristics with introduction of metakaolin source during hydrothermal synthesis. A reduced XRD pattern may also occur due to smaller crystal size of ZSM-5. The results obtained using BET surface area in Example 5 agree with the presence of mesopores and micropores indicating the nanosize transformation using kaolin clay comprising halloysite. Further, the manganese impregnated zeolite examples of Comparative Example C-1 940 and Example 3-1 950 demonstrate a crystallinity of 65% and 75% % respectively.

Ammonia temperature programmed desorption (NH₃-TPD) analysis was carried out to characterize the acid strength of the Examples and Comparative Examples. Typically, two desorption peaks in the range of 100-300° C. and above 350° C. were observed in all the analyzed samples. A low desorption peak between 100-300° C. corresponds to weak acid sites (almost Lewis), while high temperature desorption between 400-550° C. is ascribed to strong acid sites (almost Bronsted). A summary of the results is presented in Table 2.

TABLE 2

| | Amount of NH₃ desorbed (mmol/g) | | |
|---|---|---|---|
| Sample | 100-350° C. | Above 350° C. | Total acidity |
| Example 1 | 0.012 | — | 0.012 |
| Example 3-1 | 0.201 | 0.199 | 0.400 |
| Example 3-2 | 0.132 | 0.186 | 0.318 |
| Comparative Example B-2 | 0.118 | 0.105 | 0.223 |
| Comparative Example C-2 | 0.136 | 0.145 | 0.281 |
| Comparative Example C-1 | 0.132 | 0.117 | 0.249 |

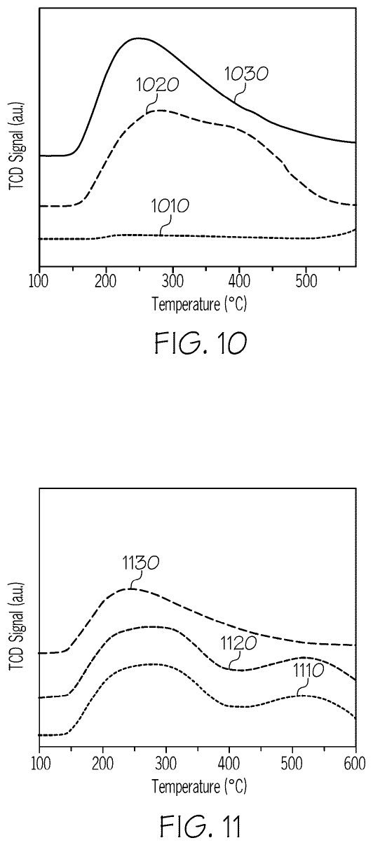

Referring to FIG. 10, the spectrum of Example 1 1010 showed very weak desorption peak at around 100-300° C., which indicates that the ZSM-5 precursor has small weak acid sites (0.012 mmol/g as presented in Table 2). The spectrum of Example 3-1 showed high NH₃ desorption peaks with integrated peak areas of 0.201 and 0.199 mmol/g corresponding to weak and strong acid sites respectively. This implies that the synthesis of ZSM-5 using kaolin comprising halloysite is a cost effective and environmentally friendly alternative for the synthesis of high acid strength ZSM-5 zeolite, while maintaining or improving zeolite function. Example 3-2, which included both manganese and phosphorus 1030 resulted in a decrease of both weak and strong acid sites of the zeolite.

Referring to FIG. 11, the spectra of Comparative Example B-2 1110, Comparative Example C-2 1120, and Comparative Example C-1 1130 are depicted. Comparative Example B-2, which was prepared using kaolin comprising kaolinite showed two NH₃ desorption peaks that correspond to the weak and strong acid sites with integrated peak areas 0.118 and 0.105 mmol/g respectively 1110. Comparative Example C-2, which incorporates 2 wt. % Mn in Comparative Example B-2, increases the total acidity to 0.281 mmol/g, although the acidity of Comparative Example C-2 was still lower than the total acidity of Example 3. The addition of TPABr template during synthesis of the zeolite followed by incorporation of 2 wt. % Mn to form Comparative Example C-1 1130 results in a decrease of strong acid sites relative to Comparative Example C-2 1120.

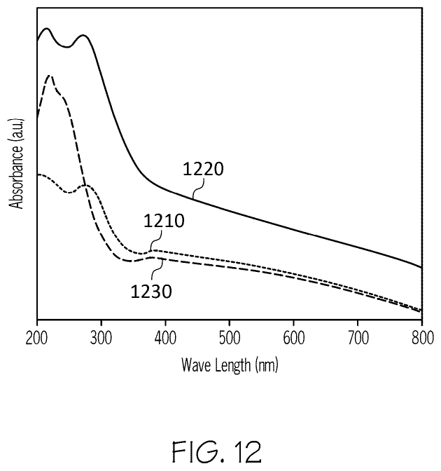

The nature of aluminum species (framework and extraframework) and influence of manganese impregnation in ZSM-5 examples and comparative examples were investigated using diffuse reflectance spectroscopy. Referring to FIG. 12, diffuse reflectance spectra of commercial ZSM-5-23 1210, Comparative Example B-2 1220, Example 2 1230, Example 3-1 1240, and Comparative Example C-2 1250 are depicted.

Commercial ZSM-5-23 1210 showed an absorption band at approximately 217 nm, which is primarily attributed to the charge transfer band indicating the presence of Al in tetrahedral coordination. Another intense peak appears with peak maxima at 275 nm, corresponding to the extraframework Al species. Comparative Example B-2 1220, which was synthesized without template using metakaolin derived from kaolinite showed a more intense two absorption bands compared to ZSM-5-23 1210. It is possible that that presence of Al—O—Si species in paired and isolated form increases the intensity of UV-visible absorption bands. Such an intense absorption indicates an effective insertion of Al in to the MFI framework. For instance, the presence of an intense peak at 211 nm and 267 nm signals in 1220 indicates such paired and isolated Al—O—Si—O—Al species. Example 2 1230 showed an intense peak of framework tetrahedral Al species higher than extraframework species. Such peak intensity demonstrates the difference of Al environment in Example 2 compared to commercial ZSM-5-23 1210 Comparative Example B-2 1220.

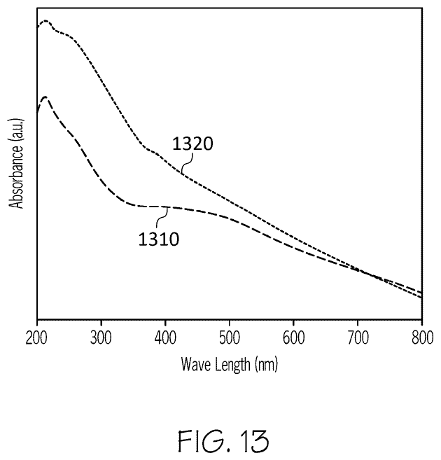

Referring to FIG. 13, diffuse reflectance spectra of Example 3-1 1310, and Comparative Example C-2 1320 are depicted. The state of manganese oxide species in Example 3-1 1310 and Comparative Example C-1 1320 were analyzed. In general, a mixed valence state of MnOₓ species were observed (Mn⁴⁺, Mn³⁺ and Mn²⁺) after calcination at elevated temperature in presence of air atmosphere. In the case of Example 3-1 1310, an intense absorption band was observed at about 250 nm indicating a charge transfer transition due to O²⁻→Mn²⁺. A small absorption band at 350 nm due to O²⁻→Mn⁴⁺ along with broad peak extending between 400 to 600 nm shows the existence of and O²⁻→Mn³⁺ charge transfer transition. Comparative Example C-1 1320 shows a mixed MnOₓ species, where a high intense Mn²⁺ along with Mn³⁺ species was observed.

### Example 8. Evaluation of Catalyst Performance for Cracking of Crude Oil Using Zeolite Compositions and Catalyst Compositions

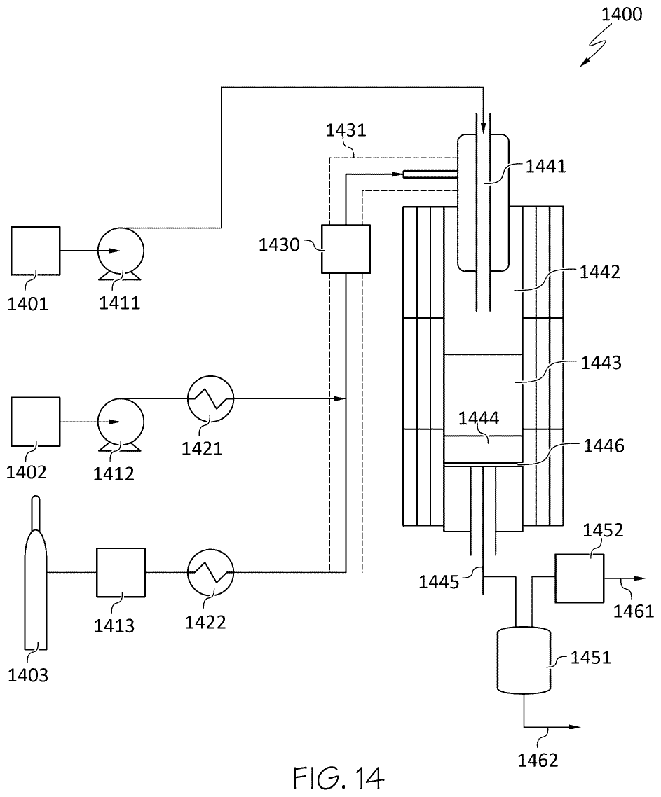

Referring to FIG. 14, Arabian extra light (AXL) crude oil 1401 was fed to a fixed-bed reactor 1400 using a metering pump 1411. The composition of the AXL feedstock is summarized in Table 3. A constant feed rate of 2 g/h of AXL crude oil 1401 was used. Water 1402 was fed to the reactor 1400 using a metering pump 1412. Water 1402 was preheated using a preheater 1421. A constant feed rate of 1 g/h of water 1402 was used. Nitrogen 1403 was used as a carrier gas at 65 mL/min. Nitrogen 1403 was fed to the reactor 1400 using a Mass Flow Controller (MFC) 1413. Nitrogen 1403 was preheated using a preheater 1422. Water 1402 and Nitrogen 1403 were mixed using a mixer 1430 and the mixture was introduced to the reactor 1400. Prior to entering the reactor tube, oil, water, and nitrogen were preheated up to 250° C. in the pre-heating zone 1442. The pre-heating zone 1442 was pre-heated using line heaters 1431. Crude oil 1401 was introduced from the top of the reactor 1400 through the injector 1441 and mixed with steam in the top two-third of the reactor tube 1440 before reaching the catalyst bed 1444. The mass ratio of steam:oil was 0.5. The crude oil was cracked at a cracking temperature of 675° C. and a weight ratio of catalyst to oil of 1:2.1 g of catalyst of 30-40 mesh size were placed at the center of the reactor tube 1440, supported by quartz wool 1443, 1446 and a reactor insert 1445. Quartz wool 1443, 1446 were placed both at the bottom and top of the catalyst bed 1444 to keep it in position. The height of the catalyst bed 1444 was 1-2 cm. The reaction was allowed to take place for 45-60 min, until steady state was reached. Reaction conditions of the fixed-bed flow reactor 1400 are listed in Table 4. The cracking reaction product stream was introduced to a gas-liquid separator 1451. A Wet Test Meter 1452 was placed downstream of the gas-liquid separator 1451. The cracked gaseous products 1461 and liquid products 1462 were characterized by off-line gas chromatographic (GC) analysis using simulated distillation and naphtha analysis techniques. As used herein, “catalyst” can refer to both zeolite compositions and catalyst compositions described in this disclosure. Unless specified otherwise, all catalytic experiments of Example 8 were carried out under the same conditions described herein.

TABLE 3

| Composition | AXL Feed |
|---|---|
| Naphtha | 40.8 |
| Middle Distillates | 26.3 |
| Heavy Distillates | 32.9 |

TABLE 4

| Conditions | |
|---|---|
| Feed Used | AXL Whole Crude |
| Specific gravity of feedstock | 0.829 |
| API | 39.3 |
| Reaction apparatus | Fixed Bed Reactor |
| Weight hourly space velocity | 3 |
| Reaction temperature, ° C. | 675 |
| Reaction temperature Range, ° C. | 600-700 |
| Steam:oil ratio | 0.5 |
| Residence time, seconds | 10 |

The reaction product streams from the cracking reaction over various zeolites were analyzed. The yield analysis for commercial zeolites ZSM-5 (23) and ZSM-5 (80), Example 2, and Comparative Examples B-1 and B-2 are listed in Table 5. As shown, Example 2 had the highest conversion yield of ethylene (19.2 wt. %) and propylene (18.1 wt. %) compared to the commercial ZSM-5 (23) catalyst (CBV 2314, Zeolyst International) and ZSM-5 (80) (CBV 8014, Zeolyst International) catalysts. Example 2 also had a higher total yield of ethylene and propylene (C₂⁼+C₃⁼) (37.3 wt. %) compared to that Comparative Example B-1 and Comparative Example B-2 (36.1 wt. % and 36.7 wt. %, respectively). These results demonstrate that zeolites derived from kaolin clay comprising halloysite can provide improved catalytic cracking compared to conventional zeolites.

TABLE 5

| | ZSM-5 | ZSM-5 | Example | Comp. | Comp. |
|---|---|---|---|---|---|
| Catalyst | (23) | (80) | 2 | Ex. B-1 | Ex. B-2 |
| Mass | 102 | 101 | 102 | 96 | 101 |
| balance, % | | | | | |
| Conversion, | 62.5 | 64.5 | 66.8 | 66.5 | 66.2 |
| % | | | | | |

Product Yields, wt. %

| | | | | | |
|---|---|---|---|---|---|
| H₂ | 0.74 | 0.64 | 0.85 | 1.00 | 0.80 |
| C₁ | 7.9 | 7.7 | 7.9 | 8.4 | 8.4 |
| C₂⁼ | 18.0 | 15.8 | 19.2 | 19.4 | 19.8 |
| C₂ | 3.8 | 4.6 | 3.4 | 3.8 | 3.8 |
| C₃ | 0.72 | 0.82 | 0.76 | 0.85 | 0.77 |
| C₃⁼ | 15.7 | 17.1 | 18.1 | 16.7 | 16.9 |
| C₄ ⁼ | 9.1 | 8.2 | 9.3 | 7.6 | 8.4 |
| iC₄ | 0.055 | 0.060 | 0.021 | 0.101 | 0.102 |
| nC₄ | 0.148 | 0.245 | 0.224 | 0.371 | 0.408 |
| Total gas | 56.3 | 55.1 | 59.8 | 58.3 | 59.4 |
| Naphtha | 25.7 | 22.5 | 22.6 | 23.3 | 24.3 |
| LCO | 8.0 | 8.2 | 7.3 | 7.1 | 6.9 |
| HCO | 3.8 | 4.7 | 3.3 | 3.1 | 2.5 |
| Coke | 6.2 | 9.4 | 7.0 | 8.3 | 6.9 |
| C₂⁼ + C₃⁼ | 33.8 | 32.9 | 37.3 | 36.1 | 36.7 |
| H₂ − C₂ | 30.5 | 28.7 | 31.3 | 32.6 | 32.7 |
| (dry gas) | | | | | |
| C₂⁼ − C₄⁼ | 42.9 | 41.1 | 46.6 | 43.8 | 45.2 |
| C₃-C₄ | 25.8 | 26.4 | 28.5 | 25.6 | 26.6 |
| (LPG) | | | | | |
| CMR* | 225.0 | 477.8 | 581.4 | 130.9 | 127.1 |
| P/E ** | 0.9 | 1.1 | 0.9 | 0.9 | 0.9 |
| C₁ − C₄ | 12.6 | 13.4 | 12.3 | 13.5 | 13.4 |
| LPG | 24.9 | 25.3 | 27.5 | 24.3 | 25.4 |
| olefins | | | | | |
| LPG | 96.4 | 95.7 | 96.5 | 94.9 | 95.2 |
| olefinicity | | | | | |

*CMR = (dry gas/iC₄).
**P/E = C₃⁼/C₂⁼.

The reaction product streams from the cracking reaction over various comparative catalysts and Example 4 were analyzed. Example 4 was steam deactivated at 810° C. for 6 hr before using in the reactor. Comparative Example 8-A is commercial catalyst (UMIX75, W.R. Grace & Co-Conn) comprising 75 wt. % equilibrium catalyst (Ecat) with USY zeolite and 25 wt. % OlefinsUltra® provided by W. R. Grace & Co-Conn. Comparative Example 8-B is an in-house-formulated catalyst made from commercially available ZSM-5 (23) having a SAR of 23 (CVB2314, Zeolyst International). Comparative Example 8-C is Ecat (Equilibrium catalyst, W.R. Grace & Co-Conn). Comparative Example 8-D is OlefinsUltra® provided by W. R. Grace & Co-Conn. Table 6 provides the summarized results of the reaction product streams from the cracking reaction. As shown, these results demonstrate that cracking the AXL oil over Example 4 had a higher yield of ethylene, propylene, and butylene compared to the comparative examples.

TABLE 6

| | | | | | |
|---|---|---|---|---|---|
| | | UMIX75 | ACA115 | Ecat | Olefins Ultra |
| | KF-25 | Comp. | Comp. | Comp. | Comp. |
| Catalyst | Ex. 4 | Ex. 8-A | Ex. 8-B | Ex. 8-C | Ex. 8-D |

Product Yields, wt. %

| | | | | | |
|---|---|---|---|---|---|
| Fuel gas | 11.8 | 7.8 | 10.5 | 10 | 7.4 |
| (C1 + H2) | | | | | |
| Saturated | 4.8 | 4 | 5.4 | 5.9 | 3.5 |
| C2 − C4 | | | | | |
| C2= | 20.8 | 17 | 17 | 16.2 | 17.1 |
| C3= | 14.7 | 16.3 | 14.9 | 14.3 | 15.7 |
| C4= | 10.6 | 9.9 | 8.1 | 9.5 | 9.9 |
| Naphtha | 13.6 | 25.5 | 17.4 | 21.8 | 28 |
| Middle | 8.5 | 10.5 | 10.4 | 8.2 | 8.5 |
| Distillates | | | | | |
| Heavy | 5.6 | 5.1 | 7.4 | 4.9 | 4.2 |
| Distillates | | | | | |
| Coke | 9.6 | 3.7 | 9 | 9.2 | 5.7 |

It will be apparent to persons of ordinary skill in the art that various modifications and variations can be made without departing from the scope disclosed herein. Since modifications, combinations, sub-combinations, and variations of the disclosed embodiments, which incorporate the spirit and substance disclosed herein, may occur to persons of ordinary skill in the art, the scope disclosed herein should be construed to include everything within the scope of the appended claims and their equivalents.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

1. A method of forming a zeolite composition, the method comprising:
calcining one or more clay mineral compositions to form metakaolin, wherein the one or more clay mineral compositions comprises greater than or equal to 10 wt. % halloysite;
forming a slurry by combining at least the metakaolin, a shape selective zeolite, a basic compound, silica particles, and a templating agent;
hydrothermally treating the slurry to form a hydrothermal product;
calcining the hydrothermal product to form a zeolite product;
combining the zeolite product and at least one metal precursor, wherein the at least one metal precursor comprises a manganese precursor, a phosphorous precursor, or both a manganese precursor and a phosphorous precursor, to form a zeolite composition comprising manganese, phosphorus, or both manganese and phosphorous.

2. The method of claim 1, wherein the one or more clay mineral compositions comprise of from 50 weight percent (wt. %) to 100 wt. % halloysite.

3. The method of claim 1, wherein the one or more clay mineral compositions comprise from 0 wt. % to 90 wt. % kaolinite.

4. The method of claim 1, wherein the one or more clay mineral compositions are naturally occurring.

5. The method of claim 1, wherein calcining the one or more clay mineral compositions comprises heating the one or more clay mineral compositions to a temperature of greater than or equal to 500° C.

6. The method of claim 1, wherein the metakaolin has an average surface area of greater than 30 m²/g.

7. The method of claim 1, wherein the metakaolin has an average pore volume of greater than 0.15 cm³/g.

8. The method of claim 1, wherein the templating agent comprises an ammonium salt, a poloxamer, or combinations thereof.

9. The method of claim 1, wherein hydrothermally treating the slurry includes heating the slurry at a temperature of greater than or equal to 100° C.

10. The method of claim 1, wherein calcining the hydrothermal product comprises heating the hydrothermal product to a temperature of greater than or equal to 400° C.

11. The method of claim 1, wherein the zeolite product is subjected to an ion-exchange process.

12. The method of claim 1, wherein the combining the zeolite product and the metal precursor comprises impregnating a metal from the metal precursor in the zeolite product.

13. The method of claim 1, wherein the zeolite composition comprises manganese in an amount of from 0 wt. % to 5 wt. % and phosphorous in an amount of from 0 wt. % to 5 wt. %.

14. The method of claim 1, wherein the shape selective zeolite is ZSM-5 zeolite.

15. A method of forming a catalyst composition, the method comprising:
calcining one or more clay mineral compositions to form metakaolin, wherein the one or more clay mineral compositions comprises greater than or equal to 10 wt. % halloysite;
forming a slurry by combining at least the metakaolin, a shape selective zeolite, a basic compound, silica particles, and a templating agent;
hydrothermally treating the slurry to form a hydrothermal product;
calcining the hydrothermal product to form a zeolite product;
combining the zeolite product and at least one metal precursor, wherein the at least one metal precursor comprises a manganese precursor, a phosphorous precursor, or both a manganese precursor and a phosphorous precursor, to form a zeolite composition comprising manganese, phosphorus, or both manganese and phosphorous;
forming a catalyst precursor comprising the zeolite composition, kaolin clay, and alumina; and
drying and calcining the catalyst precursor to form the catalyst composition.

16. The method of claim 15, wherein the alumina is treated with an acid before the combining.

17. The method of claim 15, wherein the catalyst precursor comprises from 10 wt. % to 60 wt. % of the zeolite composition, based on the total weight of the catalyst precursor.

18. The method of claim 15, wherein drying the catalyst precursor includes spray drying the catalyst precursor to form the catalyst composition.

19. A method of cracking a hydrocarbon feed stream comprising contacting the hydrocarbon feed stream with a material comprising the zeolite composition of claim 1 in a reactor to crack at least a portion of the hydrocarbon feedstream to form a product effluent comprising olefins.

20. The method of claim 19, wherein the hydrocarbon feed stream is crude oil.
